(19) United States
(12) Patent Application Publication
(10) Pub. No.: US 2010/0331041 A1
(43) Pub. Date: Dec. 30, 2010

(54) System and method for language-independent manipulations of digital copies of documents through a camera phone

(75) Inventors: Chunyuan Liao, Mountain View, CA (US); Qiong Liu, Milpitas, CA (US)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/459,175

(22) Filed: Jun. 26, 2009

(51) Int. Cl. H04M 1/00; H04N 7/18; G06K 9/46

(52) U.S. Cl. 455/556.1; 348/61; 382/201; 348/E07.085

(57) ABSTRACT

Method, device, system and framework for enabling token and point level operations on language independent paper documents through camera phone interface. Image descriptors from snapshots of document captured by the phone can be extracted by phone itself and transmitted to server. In another implementation, the descriptors are extracted by receiving server. The server is connected to database of high-quality images of the same document and matched high-quality patch is sent back to phone for user's viewing and manipulation. Modifications and annotations of high-quality patch are transmitted to database and stored. Motion detection is combined with image recognition to provide high quality images of regions of document being viewed by sweeping the phone. Capabilities include web-search, e-dictionary, or keyword finding for words in paper documents, copy-paste operations, constructing photo collages from portions of printed photos, and playing dynamic contents of printed presentation slides on display of camera phone.

### DESCRIPTION OF THE INVENTION

1. Field of the Invention

This invention relates in general to methods and systems for providing improved interaction of a user with a mobile phone and, more particularly, to using mobile phones to capture and manipulate information from document images.

2. Description of the Related Art

Paper is light, flexible and robust and has high resolution for reading documents in various scenarios. However, it lacks communication and computation capability, and falls short of providing dynamic feedback. In contrast, a cell phone, or a mobile phone, may be capable of communication, computation and dynamic feedback, but suffers from information display-related issues, such as having a small screen size and low display resolution.

Phone-paper interaction technologies are described in the existing literature and the literature is paying increasing attention to the use of mobile phones for interacting with paper documents. For example, some existing systems use document identification techniques that are text-based and language-dependent to identify text patches within paper documents. However, such systems fall short for identifying image-based content, including figures, photos and maps, as well as languages that have no spaces between words, for example, Japanese and Chinese languages. The applications intended for such existing systems focus on facilitating generation and browsing of multimedia annotations at text-patch levels for the users and do not provide fine-grained operations at token (e.g. individual English words, Japanese and Chinese characters, and math symbols) and pixel level.

Another type of systems aims at handling image-based documents such as photos and maps. One such system adopts a Scale Invariant Feature Transform (SIFT) based algorithm to identify printed photos. Another exemplary system related to cartography applications allows users to take a snapshot of a region within a map, and then retrieve a corresponding digital map for that region. It should be noted that the above exemplary systems are focusing on image content and mapping applications and do not operate well on text.

Certain augmented reality (AR) applications are also available that use mobile phones as a “magic lens” to enable the user to browse and interact with the points of interest (POI) on paper maps. For example, a user can point his or her camera phone at an area on a physical map of San Francisco, and get the captured images of the physical map augmented with dynamic content such as locations of ATM machines. However, the existing AR systems rely on visual markers to identify map regions and the “point-and-click” interactions supported by such systems are limited to a system predefined POIs.

A functionality wherein information is captured from paper has also been implemented in some systems. For instance, there are certain existing systems that enable information extraction from document images. One such system enables efficient document scanning when a user waves the document pages in front of a camera. Another exemplary system uses an overhead video camera to capture paper documents on a desk, so that a text copy can be subsequently carried out on the video images of the documents. The design of these two exemplary systems focuses on digitizing information obtained from paper documents, instead of user interaction with the paper documents. In contrast, a third exemplary system traces the paper documents and augments the paper documents with cameras and projectors located over a desktop, and supports various interactions of the user with the paper. Yet another exemplary system attaches a camera to a pen and captures images of small regions around the tip of the pen while the user is writing on the paper. The captured images are then digitally recognized to trigger execution of special commands or text extraction via optical character recognition (OCR). To this end, captured image data, which is not recognized as a special mark (such as a hyperlink) can be digitally fed into an OCR routine to extract the corresponding text. This recognized text can then serve as a parameter in a command to be executed or it can be otherwise used as input data. Such system is useful, for example, for recording page numbers.

It should be also noted that there is a rich body of research in the field of paper document identification. A popular method used in this technical area is tagging pages or patches. One exemplary system relies on RFID-tags to identify POIs in a paper map, while another exemplary system uses tags to recognize individual book pages. Other existing systems exploit visual markers for document identification, or employ human-invisible IR retro-reflective markers to specify POIs.

When interacting with the content on the paper, to achieve higher spatial resolution of locations and reduce visual obtrusiveness, fiduciary pattern techniques may be used. By spreading special tiny dot patterns in the background of the paper, systems that use such patterns can precisely locate the tip of the pen while a user is writing. Other existing works extend this idea by adopting invisible toner to avoid visual intrusiveness.

To eliminate the expense associated with augmenting the paper with special markers or patterns, some existing systems exploit the content-based document identification techniques. In addition to the above-mentioned systems, there are other systems for paper document identification, which exploit techniques based on discrete cosine transform (DCT) coefficients, OCR and line profiles, SIFT-based features, and the like.

However, despite the foregoing advances, new, more effective techniques for interacting with paper are needed.

### SUMMARY OF THE INVENTION

The inventive methodology is directed to methods and systems that substantially obviate one or more of the above and other problems associated with conventional techniques for enabling phone-paper interaction.

Aspects of the present invention combine the advantages of paper, such its light weight, flexibility and high resolution, with the advantages of mobile phones, including the capability to communicate and compute and provide feedback, through using a camera phone to access and manipulate document content.

Aspects of the present invention provide a framework for language independent document content manipulations through a camera phone and a hardcopy or other rendering of the document (such as document displayed on a display device). Aspects of the present invention can facilitate detailed document manipulation by a user without a PC or a laptop. Unlike technologies that only support linking data to a language specific paper document patch, aspects of the present invention are not limited by the language of a document. Aspects of the present invention support both image-based and text-based documents. Further, aspects of the present invention do not require special markers, RFIDs, or barcodes on the paper either. Additionally, aspects of the present invention are capable of supporting more accurate document tokens, and point level operations beyond simple data association to a text document patch. Document tokens include words, symbols and characters. Token refers to a word or a character, such as a Japanese or Chinese character, a math symbol, an icon, parts of a picture for example the lips or an eye of a person in a picture, and the like. Therefore, a token is not limited to a word in a text.

A framework according to the aspects of the present invention is built on top of a document retrieval system. Map applications built according to the aspects of the present invention can avoid using markers and therefore make room for user-defined POIs.

In accordance with one aspect of the present invention, there is provided a mobile system including a camera for capturing a snapshot of a rendering of a document; a transceiver for transmitting the snapshot to a server and for receiving a digital copy of the document matched to the snapshot; and an interface for displaying the digital copy to a user. In accordance with the aspect of the invention, the camera, the transceiver and the interface are integrated within a mobile phone.

In accordance with another aspect of the present invention, there is provided a server system including: a database for storing digital copies of a multiple rendered documents; a receiver for receiving a snapshot of a paper copy of a document, the snapshot captured from the paper document by a mobile phone; one or more processors for extracting feature points of the snapshot; a search engine for searching for a digital patch corresponding to the snapshot by matching the feature points of the snapshot to feature points of the digital patch; one or more processors for deriving a transformation matrix to transform snapshot coordinates to digital patch coordinates; and a transmitter for transmitting the transformation matrix and digital metadata to the mobile phone.

In accordance with yet another aspect of the present invention, there is provided a system including: camera means for capturing a snapshot of a rendering of a document, wherein the camera means is integrated into a mobile phone; transmitting means for transmitting the snapshot to a server; receiving means for receiving from the server a digital copy of the document matched to the snapshot; and displaying means for displaying the digital copy to a user.

In accordance with yet another aspect of the present invention, there is provided a method involving: storing digital copies of multiple rendered documents in a database together with feature points associated with each of the digital copies; receiving a snapshot of a paper copy of a document, the snapshot having been captured from the paper document by a mobile phone camera; extracting feature points of the snapshot; searching for a digital patch corresponding to the snapshot by matching the feature points of the snapshot to feature points of the digital patch; deriving a transformation matrix to transform snapshot coordinates to digital patch coordinates; and transmitting the transformation matrix to the mobile phone.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The patent or application file contains at least one drawing executed in color. Copies of this patent or patent application publication with color drawings will be provided by the Office upon request and payment of the necessary fee.

The accompanying drawings, which are incorporated in and constitute a part of this specification exemplify the embodiments of the present invention and, together with the description, serve to explain and illustrate principles of the inventive technique. Specifically:

FIG. 1A illustrates an exemplary interaction of a user with the inventive framework for the purpose of searching for the definition of a keyword within paper documents.

FIG. 1B illustrates an exemplary interaction of a user with the inventive framework for the purpose of searching for coupons for stores in a shopping mall.

FIG. 2 shows an exemplary flow chart of a method of using a framework to find a subject within paper documents, according to the aspects of the present invention.

FIG. 3 shows a flowchart of a method for performing a fast invariant transform (FIT) computation for constructing a new feature set, according to aspects of the present invention.

FIG. 4 shows a schematic depiction of constructing a FIT image descriptor, according to aspects of the present invention.

FIG. 5A shows a flowchart of a method for constructing image descriptors, according to aspects of the present invention.

FIG. 5B shows a flowchart of a particular example of the method for constructing image descriptors shown in FIG. 5A, according to aspects of the present invention.

FIG. 6 shows a schematic depiction of constructing image descriptors, according to aspects of the present invention.

FIG. 7 shows an exemplary overview of a framework for realizing digital document operations with a mobile phone and a document hardcopy, according to the aspects of the present invention.

FIG. 8 shows a flow chart of a method for performing various digital document operations with a mobile phone and a document hardcopy, according to the aspects of the present invention.

FIG. 9 shows an exemplary flow chart of a paper-phone interaction method using a command system, according to the aspects of the present invention.

FIG. 10 shows an exemplary images captured by mobile phones, which suffer from the low image quality and perspective distortions.

FIG. 11 shows an exemplary schematic depiction of a method for enhanced snapshots of a document viewed on a mobile phone, according to the aspects of the present invention.

FIG. 12 shows an exemplary flow chart of an enhance-by-original method, according to the aspects of the present invention.

FIG. 13 shows an exemplary schematic representation of a coordinate transformation between paper, mobile phone and digital documents, according to aspects of the present invention.

FIG. 14 shows an exemplary flow chart of a method for forming a transformation matrix to be utilized in conjunction with the enhance-by-original method, according to aspects of the present invention.

FIG. 15 shows an exemplary schematic depiction of the results of using a transformation matrix between phone-captured snapshots to obtain an original content, according to the aspects of the present invention.

FIG. 16A shows an exemplary schematic depiction of a real-time phone-paper interaction in a sweep mode, according to aspects of the present invention.

FIGS. 16B and 16C illustrate various exemplary phone gestures, which can be used by the user in the sweep mode to perform selection of the content.

FIG. 17 shows an exemplary flow chart of a method of providing high resolution document images through real time phone-paper interaction in a sweep mode, according to aspects of the present invention.

FIG. 18 illustrates an exemplary embodiment of a computer platform upon which the inventive system may be implemented.

FIG. 19 illustrates an exemplary functional diagram of how aspects of the present invention relate to a computer platform.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

For paper document identification, most existing systems have various requirements or constraints. Some systems use electronic markers such as RFID tags embedded in paper for document identification. Such systems suffer from low spatial resolution and high production costs. Some systems use optical markers, such as 2D barcodes, to indicate specific geographical regions on a paper map, through which users can retrieve the associated weather forecast and relevant entries in a web site with a camera phone. Generally, the introduction of markers indicates extra efforts to modify the original paper documents, and some times they are visually obtrusive and obscure valuable display real estate. To address this issue, some existing systems adopt a content-based approach, leveraging local text features, such as the spatial layout of words, to identify text patches on paper. However, these systems heavily rely on the text characteristics, and do not work on document patches with graphic content or in languages that have no clear spaces between the tokens, such as Japanese and Chinese. The tokens include words, characters, or symbols.

As for digital operation granularity, most existing systems operate at a relatively coarse granularity. Some existing systems operate on text patches with a group of words. Some focus on pre-defined geographic regions in maps, and some aim to share digital photo files. Research towards flexible token or point level operations on paper documents is rare. For example, in the category of token-based operations, a user may want to search for a single keyword, which may be an English word, a Chinese character, or a math symbol, within a paper document. Alternatively, in the category of picture-based operations, a user may wish to select portions of printed photos, such as all occurrences of pictures of a friend, and make a collage. Unfortunately, no existing systems support such camera phone applications.

In response to these issues, aspects of the present invention provide a framework to support token and point level operations with a camera phone and document hardcopy as well as other renderings of the document. The framework of the aspects of the present invention treats the document as a “proxy” of its digital counterpart, and users access and manipulate digital documents through phone-paper interaction.

A framework according to the aspects of the present invention is built on top of a document retrieval system. In one embodiment of the invention, the inventive system supports more document operations at fine granularity than multimedia annotations at patch level. Further, while the existing AR systems rely on visual markers to identify map regions, map applications built according to the aspects of the present invention can avoid using markers and therefore make room for user-defined POIs.

As known to persons of skill in the art, some document handling systems have been developed that utilize camera phones. A typical interaction paradigm in such systems is to use a mobile phone to identify a segment within a paper document, retrieve the associated digital entity, and then apply user-specified operations to the entity. Operation granularity indicates the smallest document entity to which the digital operations are applied and varies from coarse to fine. For example, at a coarse level of operation granularity, page-level and document-level operations lie and a fine level of operation granularity corresponds to point-level and token-level operations. Patch-level operations fall somewhere in between the coarse and fine levels of operation granularity. For such systems, constraints on paper documents vary from strict to loose. Systems that operate on a document with electronic markers have strict requirements or constraints, because the extra markers are necessary. And systems that operate on generic documents have loose constraints, as they require no additional identifying markers. Compared with these systems for strict and generic documents, systems that operate on documents with optical markers and systems that operate on text documents have semi-strict constraints.

Aspects of the present invention are capable of working on documents with loose constraints and fine granularity. This means that generic paper with no particular tags or makers may be used with the systems and methods of the present invention. Further, systems and methods of the present invention may be applied for point-level and token-level operations as well as other coarser levels of operation such as page-level and document-level operations. As such, the systems and methods of certain aspects of the present invention are superior to the existing art in both criteria of having a fine operation granularity and loose constraints.

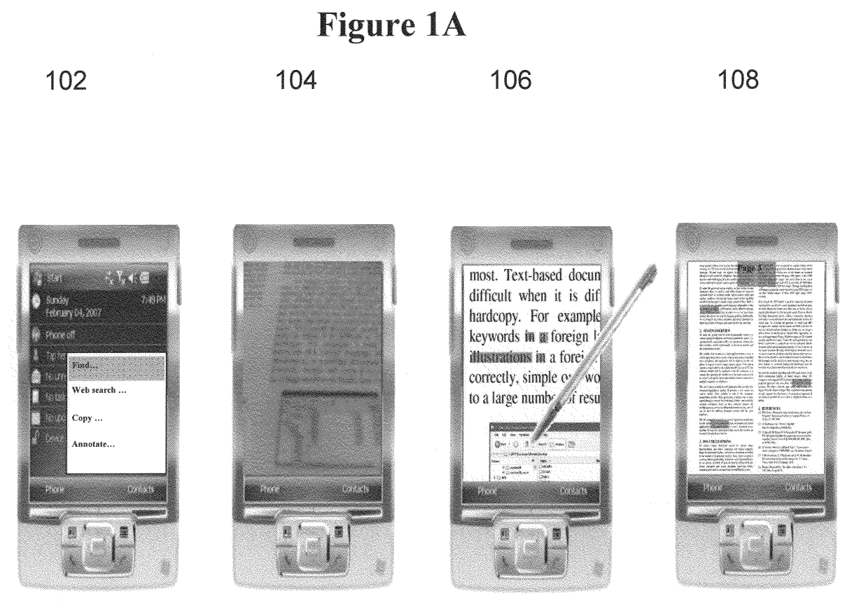

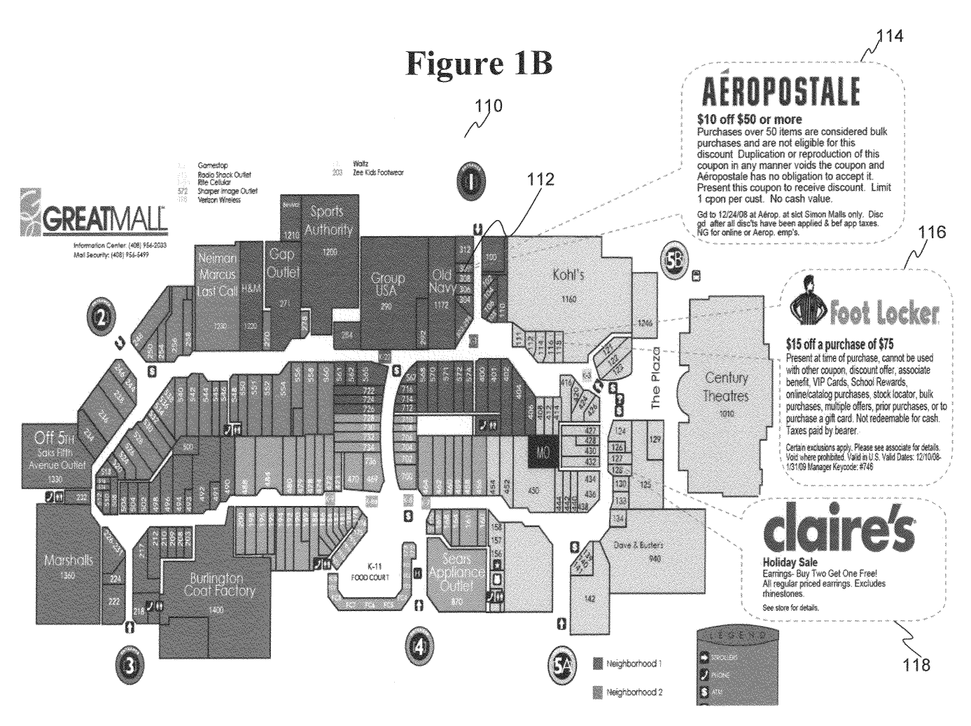

FIG. 1A shows an exemplary interaction of a user with the inventive framework for the purpose of searching for the definition of a keyword within paper documents, according to the aspects of the present invention. First, at 102, the user specifies an action “Find.” At 104, the user takes a snapshot of the paper document, with the viewfinder crosshair roughly aimed at the target word, and submits the request. This first shot may be in low quality due to lens limitations of the cell phone, bad lighting conditions and/or perspective distortion. On receiving the snapshot, the framework retrieves the corresponding high-resolution digital page from a database, where the digital images have been stored and presents the user with an enhanced snapshot and the feedback for initial selection at 106. Together with the retrieved high-resolution digital page, all other metadata associated to that region is also being retrieved. Exemplary metadata may include the text and icons, as well as their bounding boxes. These data constitute specific targets that the users will interact with on the phone at a later time. The user refines the selection, if necessary, and then issues the command again at the 106 view. After searching through the document, the framework highlights the hits found in page thumbnails at 108, which guide the user to find the information related to the selected word.

FIG. 1B illustrates an exemplary interaction of a user with the inventive framework for the purpose of searching for coupons for stores in a shopping mall by pointing the viewfinder crosshair of a cell phone camera at the stores depicted on the mall's map 201, for example store 200. On receiving the snapshot, the inventive framework retrieves the corresponding high-resolution digital map from a database together with the corresponding metadata. In one embodiment, the metadata may include the coordinates of the store pointed to by the user on the map. In another embodiment, the metadata is the numeral identifying the store on the map, retrieved using image analysis of the retrieved high-resolution digital map. The retrieved metadata may be used to identify the store(s) targeted by the user. Once the target store(s) have been identified, the inventive framework uses the store identification information to retrieve coupons 202-204 available for the targeted stores and forward the retrieved coupons with or without the retrieved high-resolution digital map to the user's cell phone.

In an alternative embodiment, the user does not target any specific store with the cell phone camera, but simply takes a snapshot of the map or a region thereof. After that, the inventive system retrieves from the database and provides the user with a high-resolution digital map. The user can subsequently use a stylus or a finger to circle a region of the map on the screen, and, responsive to the user's selection, the inventive system will query coupons 202-204 for the stores within the identified regions and provide the available coupons to the user.

It should be noted that the inventive framework is not limited to the mapping application only. The user can use the cell phone camera to take a snapshot of any graphical content and the inventive system can retrieve various types of information based on the snapshot taken by the user and the metadata associated with the snapshot.

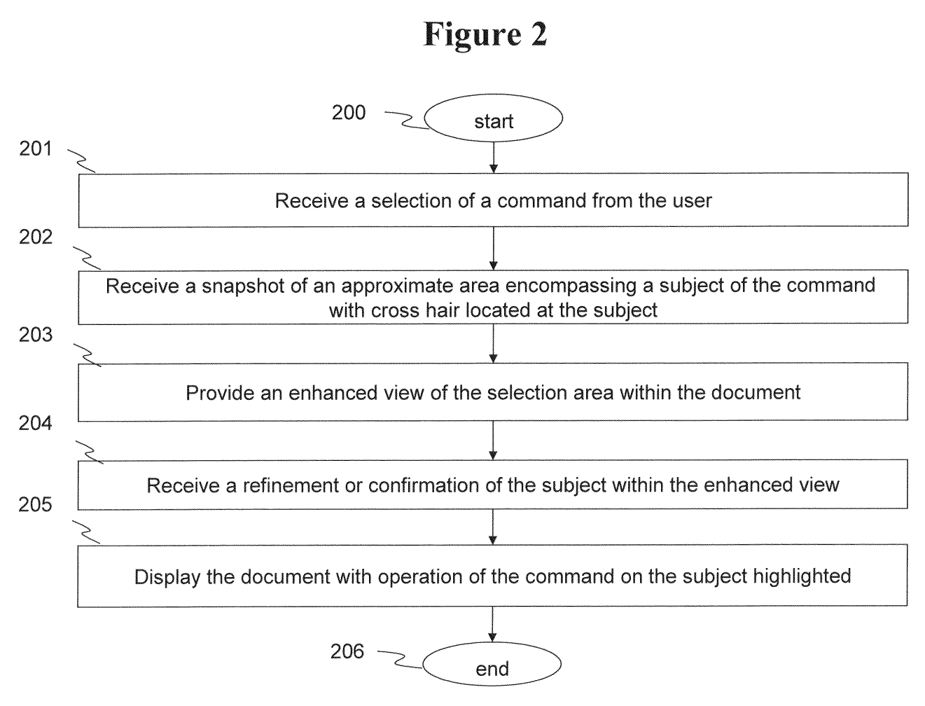

FIG. 2 shows a flow chart of a method of using a framework to find a subject within paper documents, according to the aspects of the present invention. The flow chart of FIG. 2 shows a method of using the framework of the aspects of the present invention to find a subject within paper documents. The subject to be found may be, for example, the occurrences of an exemplary word “illustration” within the document. The method begins at 200. At 201, the user specifies a command. This command is shown as the command “find” in FIG. 1. It may be some other command such as “web search,” “copy,” or “annotate.” At 202, the user roughly aims at the target word and takes a snapshot of the word that he wants found in the paper documents which is the word “illustration” in the example being presented. Effectively, at 202, the snap shot of one area of the document including a word or phrase provides the subject of the command selected to the framework. At 203 the user is provided with an opportunity to refine the selection and confirm the target word in a system-enhanced snapshot, in which the framework automatically zooms into the aimed region and highlights the words that were initially selected by the crosshair. At 204, the system receives a refinement or confirmation of the subject within the enhanced view. At 205, the framework displays the document page with the operation of the command on the subject being highlighted. For example, when the command is “find” and the subject is the word “illustration,” the document is displayed with the found instances of the word “illustration” in the document page being highlighted. At 206, the method ends.

At 203, the enhanced view that is provided to the user is received from a database located on a server that is in communication with the mobile phone, which acts as a client. In one aspect of the invention, the mobile phone extracts distinctive features of the snapshot and transmits them to the database to be matched against the available high-quality digital images. The distinctive features may be in the form of image descriptor vectors that may be obtained according to a variety of different methods. The high-quality images that are stored at the database have also been analyzed and processed for similar image descriptor vectors. In this aspect of the present invention, the image descriptor vectors of the snapshot are matched against the image descriptor vectors corresponding to the stored images. In another aspect, the image data of the snapshots is transmitted to the server and the image descriptor vectors are extracted at the server.

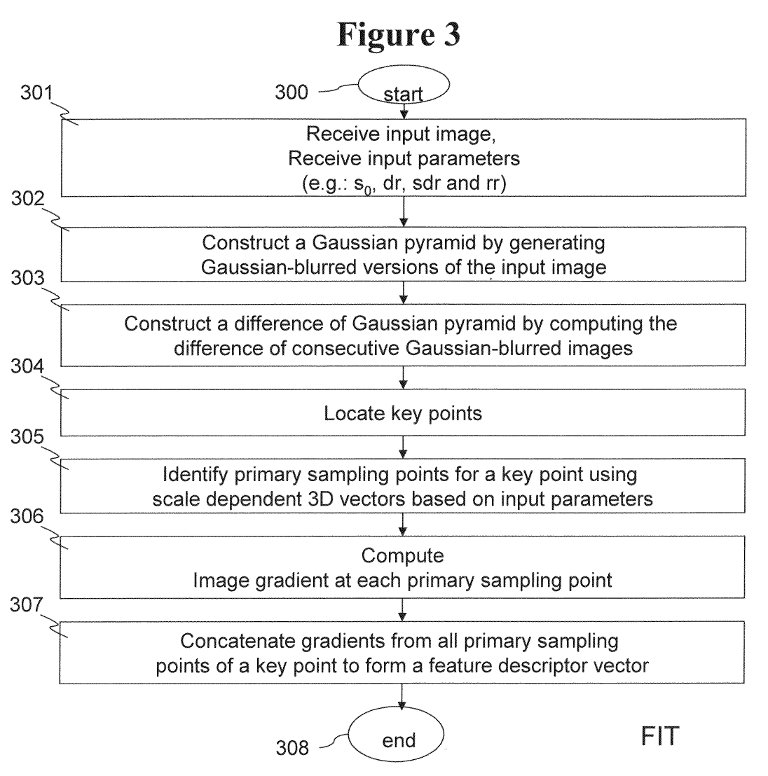

As distinct from the existing systems, aspects of the present invention accept both textual and graphic documents, and have no dependency on markers or specific languages. One aspect of the present invention uses a novel method for generating a descriptor for image corresponding point matching, which is described below with reference to FIGS. 3, 4, 5 and 6.

FIG. 3 shows a flowchart of a novel method for performing a fast invariant transform (FIT) computation for constructing a new feature set. An exemplary FIT feature construction process in accordance with a feature of the novel method begins at 300. At 301, an input image is received. Other input parameters may also be received at this stage or later. At 302, the input image is gradually Gaussian-blurred to construct a Gaussian pyramid. At 303, a DoG pyramid is constructed by computing the difference between any two consecutive Gaussian-blurred images in the Gaussian pyramid. At 304, key points are selected. In one example, the local maxima and the local minima in the DoG space are determined and the locations and scales of these maxima and minima are used as key point locations in the DoG space and the Gaussian pyramid space. Up to this point the FIT process may be conducted similarly to the SIFT process.

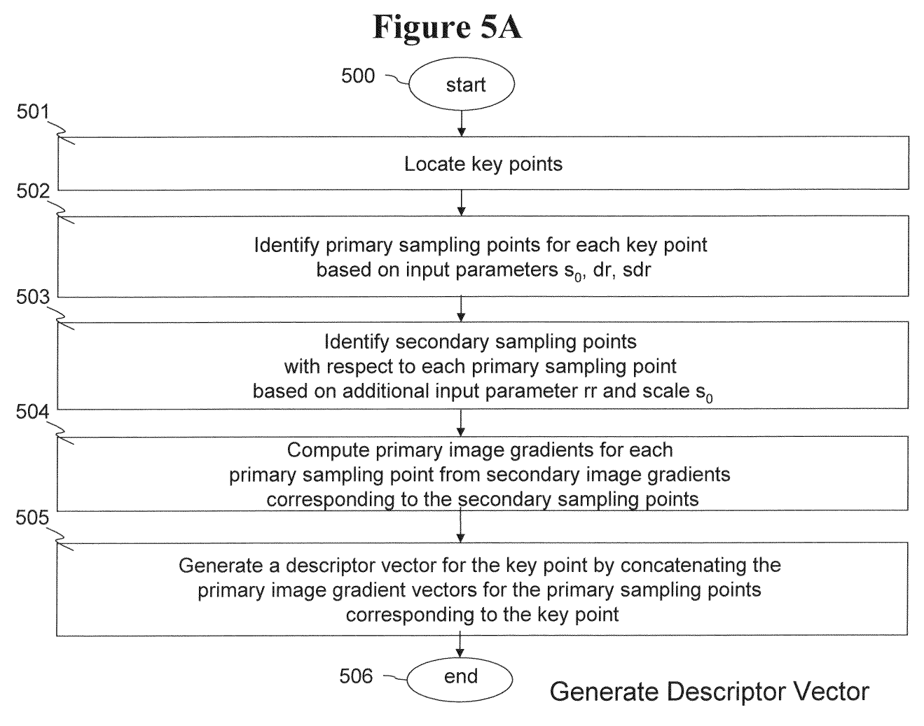

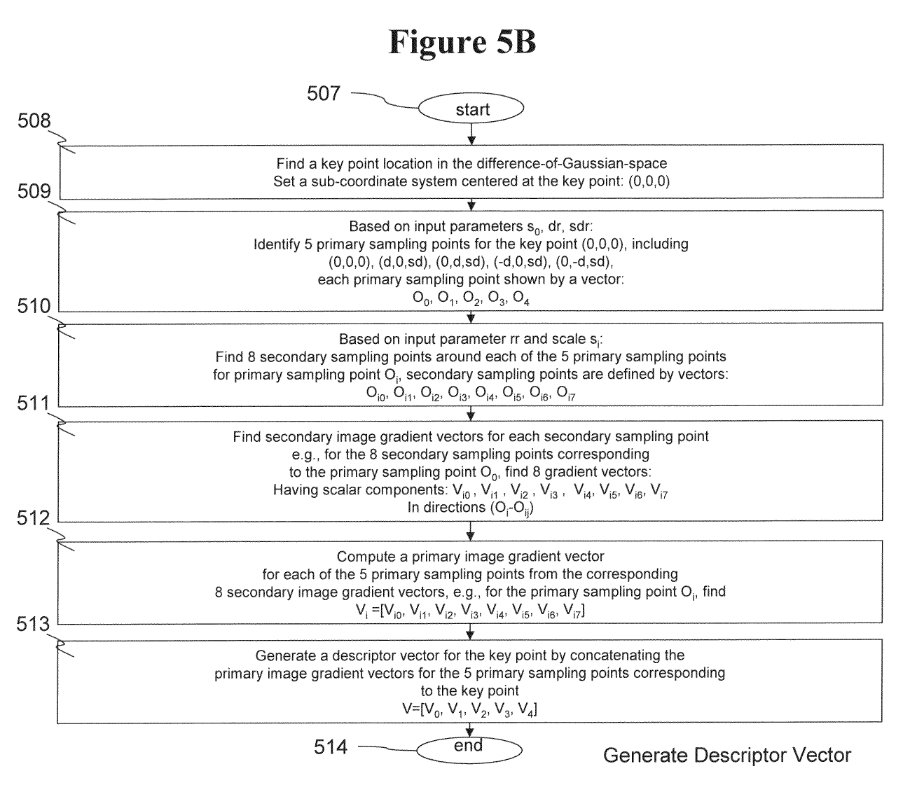

At 305, descriptor sampling points called primary sampling points are identified based on each key point location in the Gaussian pyramid space. The term primary sampling point is used to differentiate these descriptor sampling points from points that will be referred to as secondary sampling points. Several secondary sampling points pertain to each of the primary sampling points as further described with respect to FIG. 5A below. The relation between each primary sampling point and its corresponding key point is defined by a 3D vector in the spatial-scale space. More specifically, scale dependent 3D vectors starting from a key point and ending at corresponding primary sampling points are used to identify the primary sampling points for the key point.

At 306, scale-dependant gradients at each primary sampling point are computed. These gradients are obtained based on the difference in image intensity between the primary sampling point and each of its associated secondary sampling points. If the difference in image intensity is negative, indicating that the intensity at the secondary sampling point is higher than the intensity at the primary sampling point, then the difference is set to zero.

At 307, the gradients from all primary sampling points of a key point are concatenated to form a vector as a feature descriptor.

At 308, the process ends.

The FIT shown in the flowchart of FIG. 3 is faster than the conventional SIFT process well known in the art, and the reasons why are explored in this paragraph. For each 128-dimensional SIFT descriptor, a block of 4 sub-blocks by 4 sub-blocks is used around the key point, where each sub-block in turn includes at least a 4 pixel by 4 pixel area for a total of 16 pixel by 16 pixels. Therefore, the gradient values need to be computed at 16×16=256 pixels or samples around the key point. Further, it is common practice for each sub-block to include an area of more than 4 pixels by 4 pixels. When each sub-block includes an area with more than 4 by 4 pixels, the algorithm has to compute gradients at even a greater number of points. The gradient is a vector and has both a magnitude and a direction or orientation. To compute the gradient magnitude, m(x, y), and orientation, Theta (x, y), at each pixel, the method needs to conduct 5 additions, 2 multiplications, 1 division, 1 square root, and 1 arc tangent computation. The method also needs to weigh these 256 gradient values with a 16×16 Gaussian window. If gradient values are to be computed accurately for each point, SIFT also needs to do interpolations in scale space. Because of computation cost concerns, the gradient estimations are generally very crude in SIFT implementations.

Aspects of the novel method as reflected in the process of FIT, on the other hand, require 40 additions as the basic operations. Even though scale space interpolations may be used to make the gradient estimation more accurate, that cost is relatively small for interpolating 40 gradient values.

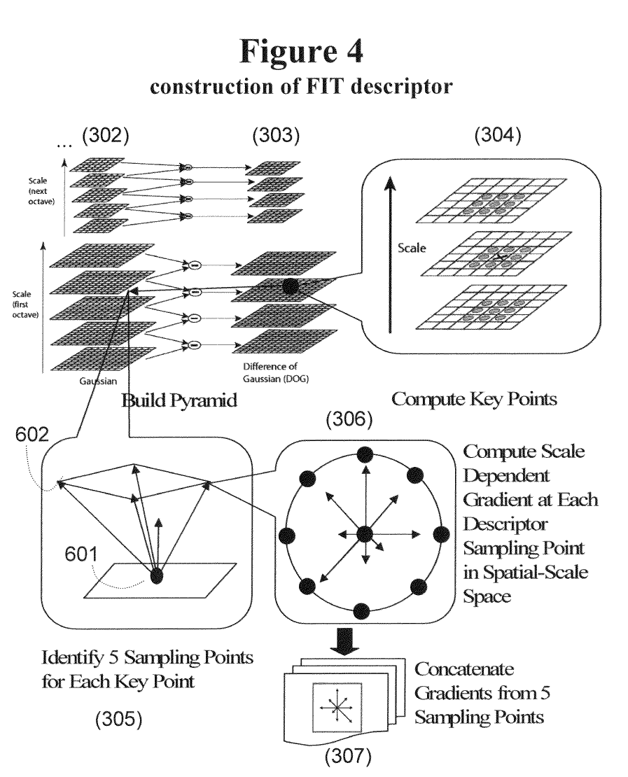

FIG. 4 shows a schematic depiction of constructing a FIT descriptor, according to aspects of the novel method.

The steps of the flowchart of FIG. 3 are shown schematically in FIG. 4. The blurring of the image to construct a Gaussian pyramid (302) and the differencing (303) to obtain a DoG space is shown in the top left corner, proceeding to the computation of the key points on top right corner (304). The identification of 5 primary sampling points 602, 601 for each key point 601 is shown in the bottom left corner (305). The computation of the gradient at each primary sampling point in the spatial-scale space (306) and concatenation of the gradients from the 5 primary sampling points to arrive at the feature descriptor vector (307) are shown in the bottom right corner.

FIG. 5A shows a flowchart of a method for constructing image descriptors, according to aspects of the novel method.

FIG. 5A and FIG. 5B may be viewed as more particular examples of stages 304 through 307 of FIG. 3. However, the image descriptor construction method shown in FIG. 5A and FIG. 5B is not limited to the method of FIG. 3 and may be preceded by a different process that still includes receiving input parameters and either receiving an input image or receiving the key points directly as well as constructing of a Gaussian pyramid which defines the scale. However, the steps preceding the method of FIG. 5A and FIG. 5B may or may not include the construction of the difference-of-Gaussian space that is shown in FIG. 3 and is used for locating the key points. The key points may be located in an alternative way and as long as they are within a Gaussian pyramid of varying scale, the method of FIG. 5A and FIG. 5B holds true.

The method begins at 500. At 501, key points are located. Key points may be located by a number of different methods one of which is shown in the exemplary flow chart of FIG. 5B. At 502, primary sampling points are identified based on input parameters one of which is scale. At 503, secondary sampling points are identified with respect to each primary sampling point by using some of the input parameters that again include scale. At 504, primary image gradients are obtained at each primary sampling point. The primary image gradients are obtained based on the secondary image gradients which in turn indicate the change in image intensity or other image characteristics between each primary sampling point and its corresponding secondary sampling points. At 505, a descriptor vector for the key point is generated by concatenating the primary image gradients for all the primary sampling points corresponding to the key point. At 506, the method ends.

FIG. 5B shows a flowchart of a particular example of the method for constructing image descriptors shown in FIG. 5A, according to aspects of the novel method.

The method begins at 507. At 508, key points are located in a difference of Gaussian space and a sub-coordinate system is centered at each key point. At 509, 5 primary sampling points are identified based on some of the input parameters one of which determines scale and the other two determine the coordinates of the primary sampling points in the sub-coordinate system having its origin at the key point. The primary sampling points are defined by vectors originating from the key point and ending at the primary sampling points at different scales within the Gaussian pyramid space. At 510, 8 secondary sampling points are identified with respect to each primary sampling point by using some of the input parameters that again include scale in addition to a parameter which determines the radius of a circle about the primary sampling points. The 8 secondary sampling points are defined around the circle whose radius varies according to the scale of the primary sampling point which forms the center of the circle. The secondary sampling points are defined by vectors originating at the key point and ending at the secondary sampling point. At 511, primary image gradients are obtained at each of the 5 primary sampling points. The primary image gradients include the 8 secondary image gradients of the primary sampling point as their component vectors. At 512, a descriptor vector for the key point is generated by concatenating the primary image gradients for all of the 5 primary sampling points corresponding to the key point. At 513, the method ends.

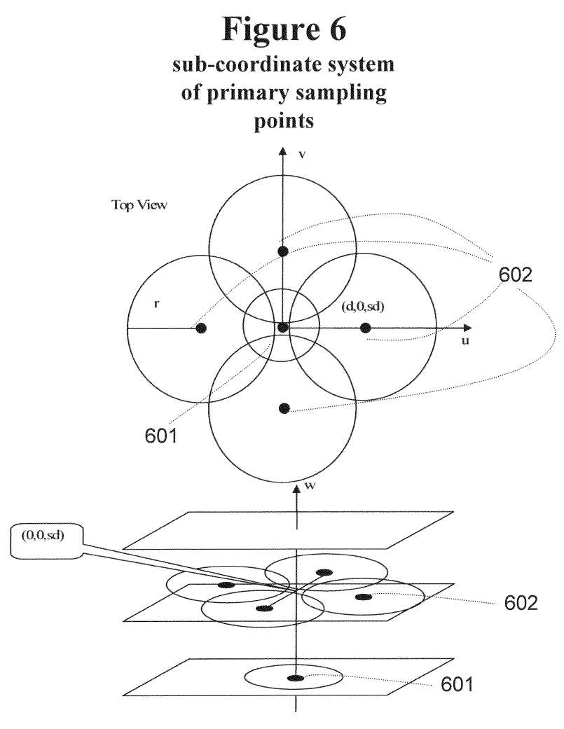

FIG. 6 shows a schematic depiction of constructing image descriptors, according to aspects of the inventive method.

In various aspects of the inventive method, the Gaussian pyramid and DoG pyramid are considered in a continuous 3D spatial-scale space. In the coordinate system of the continuous 3D spatial-scale space, a space plane is defined by two perpendicular axes u and v. A third dimension, being the scale dimension, is defined by a third axis w perpendicular to the plane formed by the spatial axes u and v. The scale dimension refers to the scale of the Gaussian filter. Therefore, the spatial-scale space is formed by a space plane and the scale vector that adds the third dimension. The image is formed in the two-dimensional space plane. The gradual blurring of the image yields the third dimension, the scale dimension. Each key point 601 becomes the origin of a local sub-coordinate system from which the u, v and w axes originate.

In this spatial-scale coordinate system, any point in an image can be described with I(x, y, s) where (x, y) corresponds to a location in spatial domain (image domain), s corresponds to a Gaussian filter scale in the scale domain. The spatial domain is the domain where the image is formed. Therefore, I corresponds to the image at the location (x, y) and blurred by the Gaussian filter of scale s. The local sub-coordinate system originating at a key point is defined for describing the descriptor details in the spatial-scale space. In this sub-coordinate system, the key point 601 itself has coordinates (0, 0, 0), and the u direction will align with the key point orientation in the spatial domain. Key point orientation is decided by the dominant gradient histogram bin which is determined in a manner similar to SIFT. The v direction in the spatial domain is obtained by rotating the u axis 90 degrees in counter clockwise direction in the spatial domain centered at the origin. The w axis corresponding to scale change is perpendicular to the spatial domain and points to the increasing direction of the scale. These directions are exemplary and selected for ease of computation. In addition to the sub-coordinate system, scale parameters d, sd, and r are used for both defining the primary sampling points 602 and controlling information collection around each primary sampling point.

In the exemplary aspect that is shown, for each key point 601, the descriptor information is collected at 5 primary sampling points 601, 602 that may or may not include the key point itself. FIG. 6 illustrates the primary sampling point distribution in a sub-coordinate system where the key point 601 is the origin. We define these primary sampling points with 3D vectors Oᵢ from the origin (0, 0, 0) of the sub-coordinate system to sampling point locations, where i=0, 1, 2, 3, 4. Therefore, the primary sampling points, corresponding to the key point which is by definition located at the origin (0, 0, 0), are defined with the following vectors:

O₀=[0 0 0]

O₁=[d 0 sd]

O₂=[0 d sd]

O₃=[−d 0 sd]

O₄=[0 −d sd]

In each primary sampling point vector Oᵢ the first two coordinates show the u and v coordinates of the ending point of the vector and the third coordinate shows the w coordinate which corresponds to the scale. Each primary sampling point vector Oᵢ originates at the key point.

In other embodiments and aspects of the novel method, a different number of primary sampling points may be used.

In the exemplary aspect that is shown in the Figures, the primary sampling points include the origin or the key point 601 itself, as well. However, the primary sampling points may be selected such that they do not include the key point. As the coordinates of the primary sampling points indicate, these points are selected at different scales. In the exemplary aspect shown, the primary sampling points are selected at two different scales, 0 and sd. However, the primary sampling points may be selected each at a different scale or with any other combination of different scales. Even if the primary sampling points are selected to all locate at a same scale, the aspects of the novel method are distinguished from SIFT by the method of selection of both the primary and the secondary sampling points.

In the exemplary aspect shown, at each of the 5 primary sampling points, 8 gradient values are computed. First, 8 secondary sampling points, shown by vectors Oᵢⱼ, are defined around each primary sampling point, shown by vector Oᵢ, according to the following equation:

Oᵢⱼ−Oᵢ,=[rᵢ cos(2πj/8)rᵢ sin(2πj/8)0]i=0 for j=1, . . . , 7

Oᵢⱼ−Oᵢ,=[rᵢ cos(2πj/8)rᵢ sin(2πj/8)sd]i≠0 for j=1, . . . , 7

According to the above equation, these 8 secondary sampling points are distributed uniformly around the circles that are centered at the primary sampling points as shown in FIG. 6. The radius of the circle depends on the scale of the plane where the primary sampling point is located and therefore the radius increases as the scale increases. As the radius increases the secondary sampling points are collected further apart from the primary sampling point and from each other indicating that at higher scales, there is no need to sample densely. Based on these 8 secondary sampling points Oᵢⱼ, and their corresponding central primary sampling point Oᵢ, the primary image gradient vector Vᵢ for each primary sampling point is calculated with the following equations:

Iᵢⱼ=max(I(Oᵢ)−I(Oᵢⱼ)), 0) in this equation Iᵢⱼ is a scalar.

Vᵢⱼ=Iᵢⱼ/[SQRT(sum over j=0 to j=7 of Iᵢⱼ²)] in this equation Vᵢⱼ is a scalar.

Vᵢ=[Vᵢ₀(Oᵢ−Oᵢ₀)/[magnitude of (Oᵢ−Oᵢ₀)], Vᵢ₁(Oᵢ−Oᵢ₁)/[magnitude of (Oᵢ−Oᵢ₁)], Vᵢ₂(Oᵢ−Oᵢ₂)/[magnitude of (Oᵢ−Oᵢ₂)], Vᵢ₃(Oᵢ−Oᵢ₃)/[magnitude of (Oᵢ−Oᵢ₃)]Vᵢ₄(Oᵢ−Oᵢ₄)/[magnitude of (Oᵢ−Oᵢ₄)], Vᵢ₅(Oᵢ−Oᵢ₅)/[magnitude of (Oᵢ−Oᵢ₅)], Vᵢ₆(Oᵢ−Oᵢ₆)/[magnitude of (Oᵢ−Oᵢ₆)], Vᵢ₇(Oᵢ−Oᵢ₇)/[magnitude of (Oᵢ−Oᵢ₇)]].

In the above equation Vᵢ is a vector having scalar components [Vᵢ₀, Vᵢ₁, Vᵢ₂, Vᵢ₃, Vᵢ₄, Vᵢ₅, Vᵢ₆, Vᵢ₇] in directions [Oᵢ−Oᵢ₀, Oᵢ−Oᵢ₁, Oᵢ−Oᵢ₂, Oᵢ−Oᵢ₃, Oᵢ−Oᵢ₄, Oᵢ−Oᵢ₅, Oᵢ−Oᵢ₆, Oᵢ−Oᵢ₇]. The direction vectors are normalized by division by their magnitude.

The scalar value I corresponds to the image intensity level at a particular location. The scalar value Iᵢⱼ provides a difference between the image intensity I(Oᵢ) of each primary sampling point and the image intensity I(Oᵢⱼ) of each of the 8 secondary sampling points selected at equal intervals around a circle centered at that particular primary sampling point. If this difference in image intensity is smaller than zero and yields a negative value; then, it is set to zero. Therefore, the component values Vᵢⱼ that result do not have any negative components. There are 8 secondary sampling points, for j=0, . . . , 7, around each circle and for each of the 5 primary sampling points, for i=0, . . . 4. Therefore, there would be 8 component vectors Iᵢ₀ Oᵢ₀/[magnitude of Oᵢ₀], . . . , Iᵢ₇ Oᵢ₇/[magnitude of Oᵢ₇] resulting in one component vector Vᵢ for each of the 5 primary sampling points. Each of the component vectors Vᵢ has eight components itself. The component vectors corresponding to Iᵢ₀, . . . , Iᵢ₇ are called secondary image gradient vectors and the component vectors Vᵢ are called the primary image gradient vectors.

### The Vectors

By concatenating the 5 primary image gradient vectors Vᵢ calculated at the 5 primary sampling points, the descriptor vector V is obtained for a key point by the following equation:

V=[V₀, V₁, V₂, V₃, V₄]

In the above equations, parameters d, sd, and r all depend on the key point scale of a sub-coordinate system. The key point scale is denoted by a scalar value sᵢ which may be an integer or a non-integer multiple of a base standard deviation, or scale, s₀ or may be determined in a different manner. Irrespective of the method of determination, the scale sᵢ varies with the location of the key point i. Three constant values dr, sdr, and rr are provided as inputs to the system. The values d, sd and rᵢ that determine the coordinates of the five primary sampling points are obtained by using the three constant values, dr, sdr, and rr together with the scale value sᵢ. The radii of the circles around the primary sampling points, where the secondary sampling points are located, are also obtained from the same constant input values. The coordinates of the both the primary and secondary sampling points are thus obtained using the following equations:

d=dr·s

sd=sdr·sᵢ

rᵢ=r₀·(1+sdr) where r₀=rr·sᵢ and sᵢ may vary with i for i=0, 1, 2, 3, 4. In one exemplary implementation, sᵢ is fixed for a particular keypoint.

The above equations all include the scale factor, sᵢ, and are all scale dependent such that the coordinates change as a function of scale. For example, the scale of the plane where each primary sampling point is located may be different from the scale of the plane where another primary sampling point is located. Therefore, as the primary sampling point changes, for example from i=0 to i=1, the scale sᵢ changes and so do all the coordinates d, sd and the radius rᵢ. Different equations may be used for obtaining the coordinates of the primary and secondary sampling points as long the scale dependency is complied with.

In some situations, the scale sᵢ of each gradient vector may be located between the computed image planes in the Gaussian pyramid. In these situations, the gradient values may be first computed on the two closest image planes to a primary sampling point. After that, Lagrange interpolation is used to calculate each of the gradient vectors at the scale of the primary sampling point.

In one exemplary aspect of the novel method, the standard deviation of the first Gaussian filter that is used for construction of the Gaussian pyramid is input to the system as a predetermined value. This standard deviation parameter is denoted with s₀. The variable scale sᵢ, may then be defined as an integer or non-integer multiple of s₀ such that sᵢ=mᵢ s₀. In other examples the variation of sᵢ is determined in a manner to fit 3 planes between the first and last planes of each octave as shown in FIG. 2 and FIG. 4.

The above-described novel method uses low level image features to index and retrieve documents, and can achieve a 99.9% recognition rate on a preliminary 1000-page testing set. Moreover, it supports digital operations at various granularities from pixel level to document level. This feature extends the input vocabulary of the phone-paper interaction. The framework of the aspects of the present invention opens the door to a rich set of applications. In addition to the word-finding function, aspects of the present invention also support web search, photo-collage, fine-grained multimedia annotations, copy, paste and the like.

In addition to a “find” application, for finding words that is presented above as an example, the framework of the aspects of the present invention also enables a rich set of phone-paper applications that are not available in the existing systems of this field.

Operations such as web searches and dictionary searches are generally considered token-level operations. However, aspects of the present invention are adapted to performing the same operations on generic documents that do not include markers. People often encounter unfamiliar words while reading. While it is possible to manually type the word on a mobile phone for web search, aspects of the present invention enable a more convenient “point-and-click” interaction for the users to launch the search action. Similar interactions are also applicable to electronic dictionary applications, which can provide multimedia information such as pronunciations and video illustrations for the selected words. Even though certain OCR-based systems like PaperLink also offer a “dictionary” function, the conventional systems do not provide the aforesaid token-level operations on generic documents.

Copy-Paste operations may be one of the most frequently used digital operations on computers. However, such powerful tool is usually not available on paper documents. The framework of some aspects of the present invention is capable of supporting this function on general documents. A user can extract an arbitrary region containing texts, images, tables or mixed content from paper, put them in system clipboards, and later paste them to emails or notes, or attach them as annotations to a word or a symbol on paper. Other existing systems may support similar functions to some degree. However, these systems are usually constrained by the genre of the data or by augmenting markers. For example, some of the existing systems work on text-only but cannot work on just any generic document.

Generating a photo collage is another aspect of the present invention. Printed photos may have advantages over their digital counterparts in face-to-face communication among people, but these physical artifacts can not benefit from the powerful digital processing for various visual effects. Some existing systems allow a user to retrieve and share digital photos with a snapshot of the corresponding printed photos. These systems, however, work only at file level granularity. Aspects of the present invention extend the photo collage idea to more fine-grained photo manipulations. For example, using some aspects of the present invention, a user can select regions in printed photos, such as the occurrences of his girlfriend, apply various visual effects, and create a collage by using another tool that is suited for creating photo collages. Then the user can elect to print the collage or email it to others.

Playing the dynamic contents of handouts is another application suitable for some aspects of the present invention. Printed slides generated by a presentation software are often used as handouts for presentation or lectures. Although paper handouts are easy to mark up and navigate, dynamic information embedded in the slides, like animations, video and audio, are lost when the slides are printed. For example, using the interface, a user can aim a camera phone at a video frame window on paper, and then retrieve the multimedia file to be played on the phone. Likewise, she can also play the slides and watch embedded animations.

The following description begins with an overview of the framework and continues with a discussion of the building blocks of the framework and possible applications.

Aspects of the present invention recognize generic paper documents and map phone-paper interactions to digital operations. Aspects of the present invention handle limitations of camera phone-based interfaces to support user manipulation of token and point level document contents. The capability of recognizing generic paper documents refers to the capability of the aspects of the invention to recognize documents having no language dependency and no markers. The limitations of camera phone-based interfaces refer to low quality of camera images and small displays. By integrating the document recognition and user interface techniques, aspects of the present invention provide a novel framework to support a broad range of language-independent manipulations of hardcopies of documents through a camera phone. The hardcopies that are manipulated may be markerless and do not require to be tagged or otherwise marked.

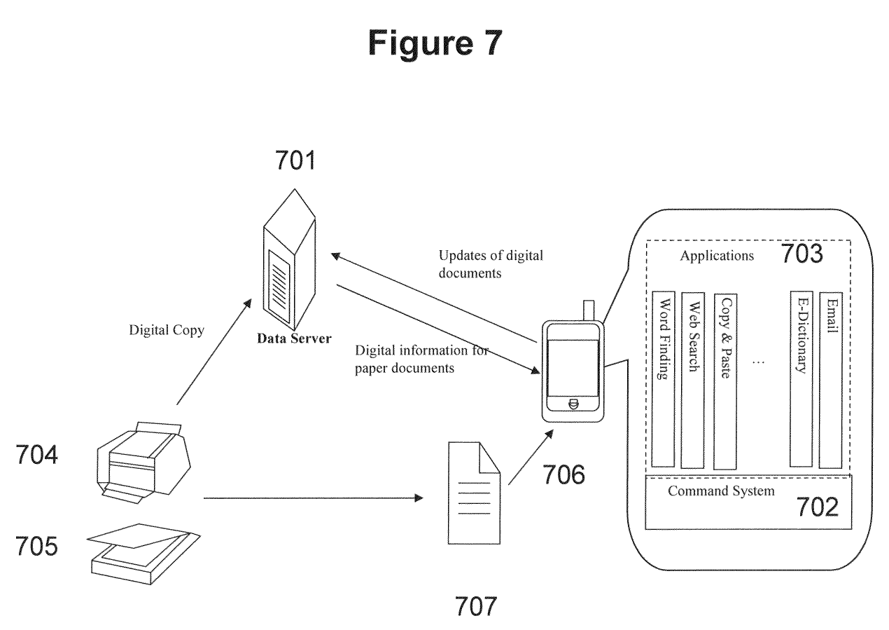

FIG. 7 shows an overview of a framework for realizing digital document operations with a mobile phone and a document hardcopy, according to the aspects of the present invention. Specifically, this figure shows a framework, according to one aspect of the present invention, including a data server 701, a command system 702 and a document service package 703 which includes a number of applications. Both the command system 702 and the document service package 703 reside and run on a mobile telephone 706.

A mobile phone 706 is shown that operates as a client to the data server 701. Therefore, in this written description, the term “client” refers to the mobile phone in contact with the data server.

The data server 701 acts as a repository of documents. In one embodiment, the server 701 executes on a separate computer platform. In an alternative implementation, it executes on the same camera cell phone used to take the snapshot of the document. A printer 704 is shown that can print the digital copies received from the server 701. The printer can also print a digital document from a computer, and the image of the document is automatically sent to the server 701, and then indexed and stored as a digital copy in a database at the server 701. Other metadata associated to the image (e.g. the digital document itself, the text and icons, and their bounding boxes) can be sent to the server 701 too. A scanner 705 is also shown that can scan a hardcopy 707 and convert it into a digital copy that may be in turn stored on the data server 701. When a user scans the hardcopy 707 at the scanner 705, the image of the document is automatically sent to the server 701, and then indexed and stored as a digital copy in a database at the data server 701. Subsequent to the formation of the database, the user can utilize the mobile phone 706 to query the server for information in specified paper documents, for example for page images and texts, and to perform digital operations. Users can also modify the document content, such as by adding a voice annotation to a figure in the document. These modifications and updates may be applied to the document at the mobile phone 706 and the updated versions of the document are subsequently sent to the server for being saved. Alternatively, the modifications and updates are submitted to the server 701 and applied to the documents at the server.

The phone-paper interaction is conducted by the command system 702 running on the mobile phone 706. The command system 702 functions in a similar manner to a Linux or Windows shell program. For users, it provides a unified way to select a command, or an application, specify command targets and adjust parameters. For applications, it offers a set of application programming interfaces (APIs) to process raw user inputs such as captured images, key strokes and stylus input, and interacts with the server 701 to retrieve and update information associated with paper documents.

In some aspects of the present invention, the applications at the command system 702 focus on specific operations to facilitate the interaction of the users with documents. With support from the command system, a broad range of applications can be provided, such as document manipulation and photo editing. Other examples of the applications supported by the command system are email, e-dictionary, copy and paste, web search, and word finding.

The data server and the command system of the aspects of the present invention, together, provide a platform for a wide range of novel applications. Users can benefit from the framework which combines the advantages of paper and mobile phones.

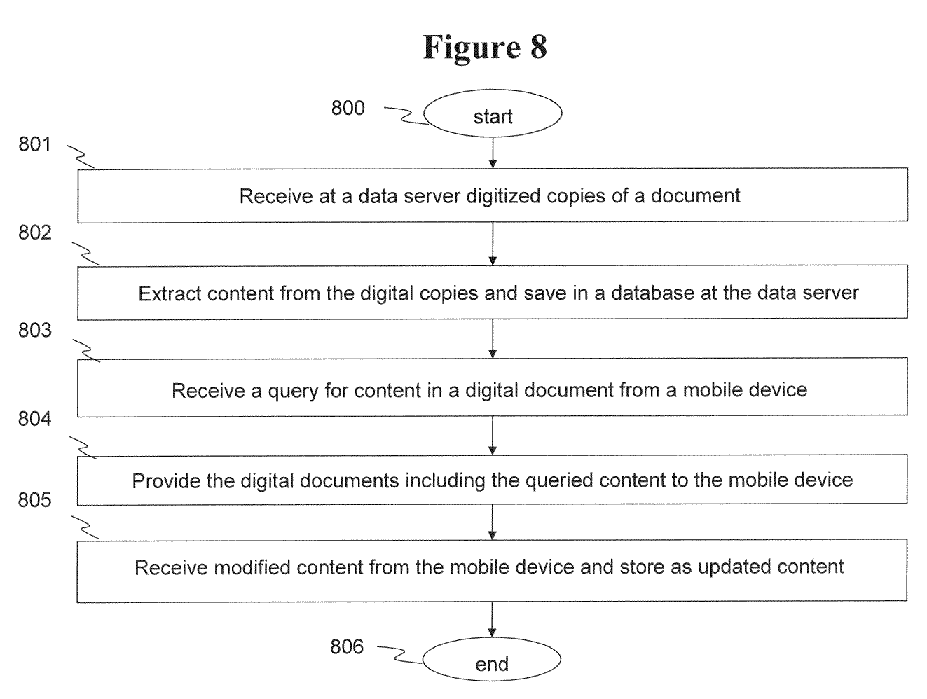

FIG. 8 shows a flow chart of a method of realizing digital document operations with a mobile phone and a document hardcopy, according to the aspects of the present invention. The method begins at 800. At 801, digitized copies of a document printed, scanned or otherwise digitized by a user are received at a data server and at 802 the digital copies are stored in a database. The material that is stored in the database may include complete documents as well as portions or contents of each of the documents. At 803, a query is received at the data server from a mobile device for content such as images or words that may be part of one of the documents stored in the database. In one aspect of the present invention, the document query of 803 may be performed according to the novel FIT method described above. At 804, the documents including the queried content are sent from the data server to the mobile device. Alternatively, only the content that is requested, or a patch including that content, is retrieved from the database and sent to the mobile device instead of sending the complete document or a full page. At 805, the content may be modified at the mobile device by the user and the modified content received back at the data server and stored at the data server as modified or updated content. At 806, the method ends.

The following portions of the written description provide further detail of the document identification process at the server side and the command system at the client side. For example, snapshot-based document queries and the basis phone-paper interaction using the command system are described in further detail.

In one exemplary aspect of the present invention, the novel FIT method described above may be adapted for conducting the document query. This method uses low-level image features to represent document pages. Without using any text-specific or picture-specific information, the method is able to work on generic documents, and does not rely on certain languages or markers. This property is one feature that distinguishes the framework of the aspects of the present invention from other art in the area of phone-paper interaction. Aspects of the present invention, however, are not limited to the above method of conducting document queries. Other methods for detecting features in generic documents that do not depend on markers embedded in the document or on the shape and organization of text or a particular language may be used in various aspects of the present invention.

When a new digital document is submitted to the server, feature extraction is performed on each page of the document, and the extracted features are stored in the database. When a user submits a snapshot as a query, the same feature extraction algorithm is applied, and the extracted features are matched to those in the database. The server returns top matching candidate pages in decreasing order of similarity. Once the user finds the desired document pages from the documents returned by the server 701, the user can manipulate the documents via the command system 702 that is usually implemented on the mobile telephone 706.

At 805, the content may be annotated at the mobile device by the user and provided back to the server. Fine-grained annotations provide one example of the applications of the aspects of the present invention. Most paper-phone applications merely extract information from paper documents, but some aspects of the present invention also allow for adding digital information to or even editing the documents via phone-paper interaction. In some aspects of the present invention, the framework uses printouts as a proxy of their digital copies, so the commands issued via mobile phones and paper are effectively applied to the corresponding digital documents.

Aspects of the present invention support multimedia annotations attached to the specified paper document; are not limited to specific languages or document genres; and offer fine-grained annotations. For instance, after performing a web search for a French composer name “Olivier Messiaen” in a printout, a user selects a good introductory web page of the composer, and attaches it as an annotation to the name on paper. The updates on the paper are committed to the digital files at the server side, so that the user can later download a new digital version with a hyperlink automatically created for the name Olivier Messiaen.

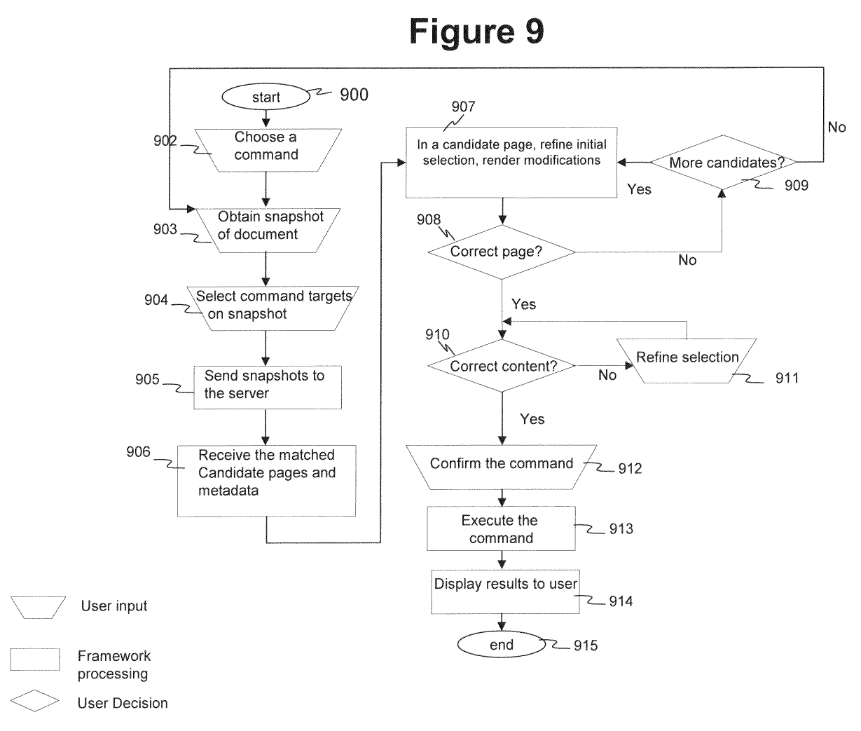

FIG. 9 shows a flow chart of a paper-phone interaction method using a command system, according to the aspects of the present invention. This figure illustrates the basic client-side user operations and data processing when a user issues a command using the mobile phone. The user first takes a snapshot of a paper document segment, and selects the command targets within the snapshot by tapping, underlining or lassoing the targeted words or image regions. In one exemplary aspect, this step could be skipped if the user has selected the target when taking the snapshot with the phone's viewfinder crosshair aimed at the target. The snapshot is then submitted to the data server to retrieve the corresponding digital document page and other metadata. Based on the server feedback, the user checks if the correct digital copy is returned and if the initial selection is precise, and makes necessary adjustment. Finally, a digital document ID, command targets and parameters are passed to the specified application to actually execute the command. By using this method, a blurry and low quality image of a document procured by the user's mobile phone may be replaced, in accordance with the preference of the user, with a sharp digital image of the same document for user's viewing and manipulation.

The flow chart of FIG. 9 begins at 900. At 902, the user is given the opportunity to select a command on his mobile phone. At 903, the user takes a snapshot of a paper document that contains the target of the command that was selected. For example, if the command was “copy,” the user takes a snapshot of the document with the crosshair of the camera at the phrase or word that he wants copied. At 904, the user either selects or refines the selection of the command target on the snapshot by underlining or otherwise selecting the target words or phrases. At 905, the snapshot is sent from the phone to the server. At 906, the mobile phone receives the matched candidate pages and the metadata associated with those matched pages. Also, in some aspects of the invention, instead of receiving matched document pages, only patches or portions of a page may be received that match the snapshot. At 907, the received candidate page is examined and may even be modified by the user. At this stage, the user may further refine his selection on the better quality digital image that he is now viewing. In an alternative implementation, the user can also opt for refining his or her selection on the original snapshot, if its quality is acceptable. The user may also modify or annotate the content of the page that he is viewing at this stage. At 908, the mobile phone receives an input from the user regarding the precision of the received document page. If the document page that is received is correct, the process moves on, otherwise and if the content that is received is not what was intended by the user, at 909, the mobile phone checks whether more candidate content pages are available. If more candidate pages are available to be provided by the server, the process of steps 907 and 908 repeats. When the document page sent by the server and received by the mobile phone is correct or when all the candidate pages provided by the server have been reviewed, the process moves to 910. At 910, the user verifies that the content that has been selected and, for example, highlighted by the server is correct. If the selection is not correct, at 911, the user is provided with the opportunity to refine the selection by, for example, tapping, underlining, lassoing within the document shown on the phone. If the correct selection of the correct content on the correct document page is received, then at 912, the user provides the required parameters for carrying out the command to the application on the mobile phone. For example, the document ID of the appropriate document, the command “search” and the selection “illustration,” are all provided to the application “keyword search” on the command system of the mobile phone. At 913, the mobile phone executes the command. At 914 the results are displayed to the user and at 915 the process ends. In some cases, the aforesaid steps 911 to 914 could be repeated multiple times. In one example, a user takes a snapshot of a music score, and gets it recognized through the inventive framework. Now within the digital score shown on the phone, she can use a style to draw a line along a staff to continuously play notes in the selected section. While she doing this, each point of the drawn line is captured and immediately sent to the command “music play”. In other words, for each point, the steps 911 to 914 are performed. Such repetition will continue until the user lifts her stylus from the screen.

The design of the command system of the mobile phone that includes the applications is further described below. The general function of the command system 702 of FIG. 7 is to facilitate the following for the users: specifying a command action (i.e. an operator), selecting command targets (i.e. the operands) and setting command-specific parameters when necessary. Some aspects of the present invention focus on coupling paper documents and a mobile phone for target selection, and use only the phone to specify actions and parameters.

For selecting targets on the snapshot of paper document various methods may be used. To select a keyword, the user may aim the camera phone at the word and click a button. To select a region in a printed photo, the user may draw a lasso on the snapshot with a stylus.

One aspect of the present invention places emphasis on selecting detailed document content with distorted low-resolution snapshots. The distorted and low-resolution snapshots are replaced with high quality digital versions previously stored in the database and are provided to the user. On the other hand, in an embodiment of the invention, if the snapshot is of good quality, the replacement image is not provided as it is not necessary.

Phone-captured images usually suffer from low resolution and distortions, and a generally low quality, which presents difficulties for users to make precise selections and for systems to identify the selected area. Although there are known algorithms for image enhancement and distortion correction, these algorithms are usually computation expensive for being implemented in the mobile phones and are hard to generalize. Aspects of the present invention include approaches that overcome these issues.

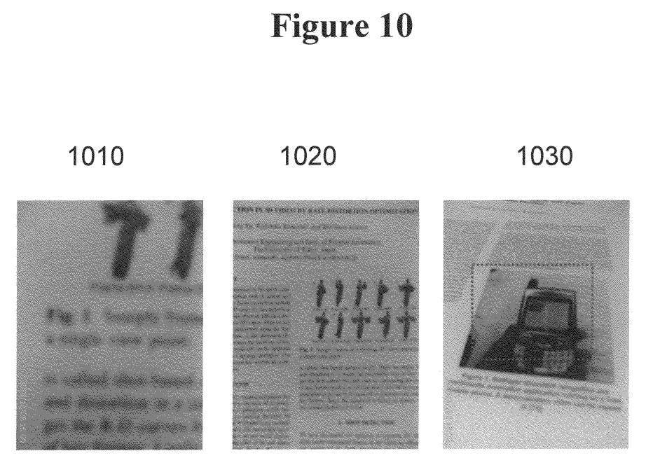

FIG. 10 shows a schematic depiction of focusing on a document using mobile phones. Three views are shown in FIG. 10. View 1010 shows a close-up snapshot. View 1020 shows a focusing distance snapshot. View 1030 shows a snapshot with perspective distortion. Aspects of the present invention handle low image quality of the mobile phones. Many mobile phones use a fixed focal length that is set for general scenes or portraits, so they can not focus well for close-up paper documents as shown in view 1010. If the snapshot is taken from too far away, such that the document is at the focusing distance, then the text appears too small. Further, if the camera resolution is not sufficiently high, focusing and zoom-in does not help very much as shown in view 1020. On such snapshots, it is difficult for users to precisely select individual words. Although image enhancement procedures such as de-blurring and super-resolution might be adopted before selection, these procedures are computation-intensive and impractical for mobile phone applications. To address this issue, the aspects of the present invention utilize an enhance-by-original method presented below.

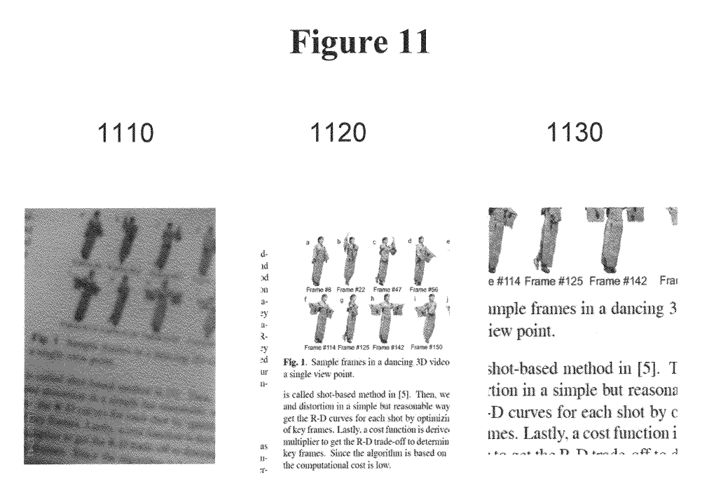

FIG. 11 shows a schematic depiction of enhanced snapshots of a document viewed on a mobile phone, according to the aspects of the present invention. A raw snapshot 1110 and its corresponding enhanced versions 1120 and 1130 are shown in FIG. 11. The raw snapshot 1110 has a low quality and is distorted. A high-quality patch to replace the original snapshot is shown in the enhanced version 1120. As the drawing shows, the snapshot 1110 is blurry and suffers from perspective distortion and is capturing a piece of the text at a tilted angle such that some of the text and the images in the document are cut off. In the patch 1120, the blur, distortion and tilt issues no longer appear. In the enhanced version 1130, the user can zoom into the details of the high-resolution patch 1120.

In the enhance-by-original method shown schematically in FIG. 11, the raw snapshot 1110 is sent as a query to the server to search for the original document of high resolution. The original high resolution document 1120 is then used to replace the raw snapshot. Compared to image processing methods, this approach can normally provide much clearer views at various zoom levels and is useful for very detailed document operations. Aspects of the present invention differ from the use of digital map patches for masking visual markers in the camera images of a physical marker-augmented map that use fixed patches to replace fixed portions of the map. Instead of being limited to fixed patches, aspects of the present invention may enhance any part of a generic document.

High quality and high resolution copies of the document may be provided to the server when the users are printing or scanning. Therefore, these aspects of the present invention assume that high quality copies of the documents that users are interacting with are available in the data server. Once a snapshot is submitted by the mobile phone, the server extracts its feature points and searches for the corresponding high quality copy. From the matched feature point pairs between the snapshot and the high resolution copy, a transformation matrix is derived that can transform the snapshot coordinate system to the coordinate system of the high resolution, or generally high quality, copy. Then, this transformation matrix can be used to find the patches matched to the raw snapshot. The patch and transformation matrix, as well as metadata associated to the patch (e.g. text, icons, and their bounding box definitions in the digital page coordinates) are then sent back to the mobile client to enhance the user interface.

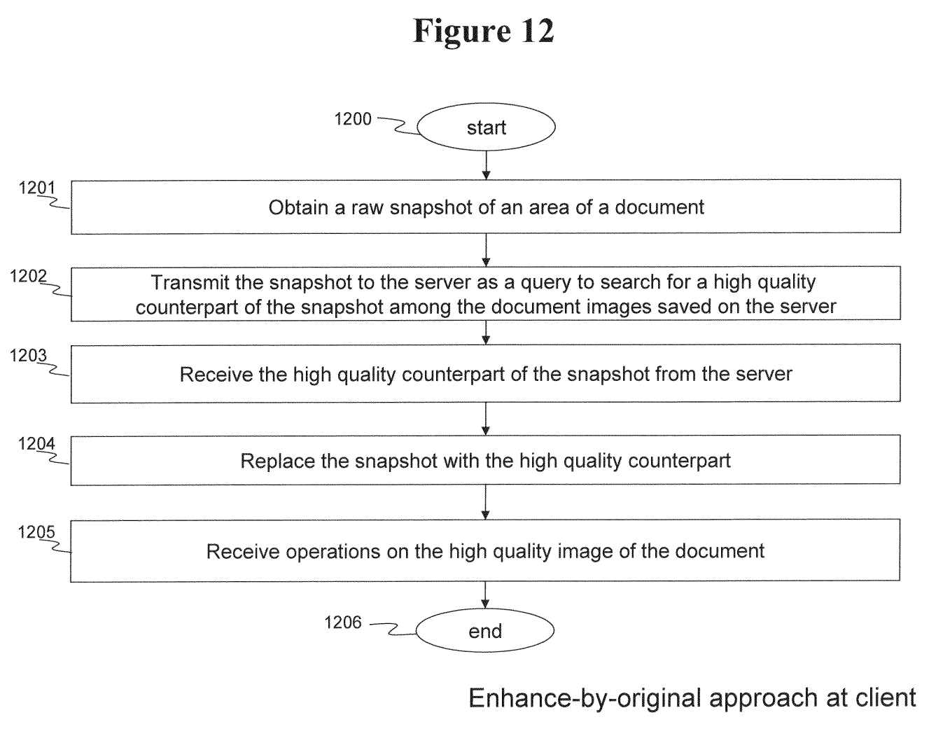

FIG. 12 shows a flow chart of an enhance-by-original method, according to the aspects of the present invention. This figure shows a method corresponding to the enhance-by-original steps shown in FIG. 11. The method begins at 1200. At 1201, the mobile phone obtains a raw snapshot of an area of a document. At 1202, the raw snapshot is sent to the server as a query for finding a high quality counterpart for the raw snapshot. The server has a database that includes high quality digital images of the documents being viewed through the mobile phone. The high quality digital image corresponding to the raw snapshot may be present on the server. At 1203, the mobile phone receives the high quality counterpart of the snapshot from the server. At 1204, the mobile phone replaces the low resolution and distorted raw snapshot that was captured by the mobile phone with the high quality counterpart received from the server. At 1205, the user is permitted to perform operations on the high quality counterpart, such as panning, zooming, tapping or lasso to verify and confirm command targeted content. At 1206, the method ends.

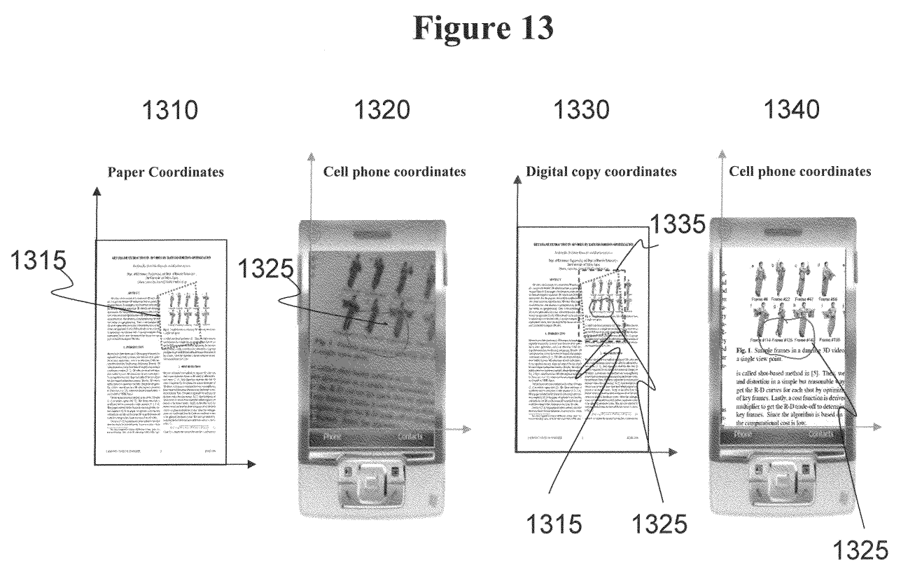

FIG. 13 shows a schematic representation of coordinate transformation between paper, mobile phone and digital documents, according to aspects of the present invention. This figure shows the coordinate systems on a piece of paper 1310, a mobile phone screen showing an image or a captured snapshot 1320 of the same piece of paper, a digital high resolution copy 1330 of the piece of paper as stored in a database and again an enhanced image 1340 of the piece of paper on the mobile phone screen. A source patch 1315 is shown on the piece of paper 1310. This source patch 1315 corresponds to the distorted area that is captured by the mobile phone and shown as the captured snapshot 1320. The captured snapshot 1320 includes a lasso 1325 made by the user for conveying an initial selection. The matched patch 1315, its bounding box 1335, and the lasso 1325 are shown within the original high-resolution digital copy 1330. The enhanced interface 1340 results from the matched patch within the box 1335. The original snapshot 1320 was distorted and therefore the actual snapshot area that is shown as the source patch 1315 is not rectangular when shown on the actual document. However, the bounding box 1335 that is determined to encompass the source patch 1315 is rectangular and the image corresponding to this rectangular box 1335 is what is presented to the user in view 1340. Further, because the initial lasso 1325 was entered on the distorted view of 1320, in the enhanced interface 1340 the initial lasso 1325 has also been transformed, such that selection refining might be needed for precision.

Aspects of the present invention include automatically panning and zooming into the high-resolution patches, handling image distortion, handling text selection and using metadata from the server as further described below.

Although the high-resolution patches from the server can enhance the raw low-quality snapshots, to select details in the patches, users may still need to pan and zoom into the snapshots to check the feedback and refine initial selection. To ease this procedure, upon receiving the patches, the client automatically centers the initially selected command targets in the screen, and zooms in at such a level that the bounding box of the targets takes a certain portion, for example 50%, of the phone's display real estate. The users can then forego a manual pan-zoom step, and more easily refine and confirm the selection. FIG. 1, view 106 illustrates a result of the auto-pan-zoom operation.

In case of a high-end camera phone, the user may be able to take a clear snapshot of the command targets at a focusing distance. However, the selection of an area on the snapshot still involves a challenge. This is because image distortion, such as rotation and perspective distortion, makes the region selection difficult. As illustrated in view 1030 of FIG. 10, a rectangular are on a paper document may appear like a rotated trapezoid on the mobile phone screen. A normal marquee widget in the phone coordinate system can not precisely fit the intended rectangular region in the paper coordinate system.

For handling image distortion, alternatively, the user can tap the four corners of the figure and define a polygon region selection. However, this method forces the user to mentally transform the shapes from the mobile phone coordinate system to the paper coordinate system, which may increase the cognitive load of the user. Light conditions also affect the snapshot image quality. For instance, a mobile phone held closely to the targeted paper documents may cast a shadow on the targeted paper documents.

Further, although it is possible to apply image processing to the new snapshots it is hard to generalize image processing to compensate for various distortions. Therefore, the aspects of the present invention utilize the enhance-by-original approach. One aspect of the enhance-by-original approach was summarized in the flow chart of FIG. 12. In the enhance-by-original approach, the server is queried with a snapshot for the transformation matrix between the snapshot and the original page. The transformation matrix is then used to correct the image distortion. Therefore, the users can apply the conventional selection widgets within the corrected snapshot. This approach is computationally efficient.

Regarding text-selection, some applications such as keyword-finding need the text of the selected words on paper, but the image quality of snapshots may not be sufficiently high for optical character recognition (OCR). Moreover, some math symbols and foreign characters do not exist in OCR packages. To solve this issue, the server can also be queried to obtain the tokens contained in a snapshot. If the document stored in the data server has a textual format, the position and bounding boxes of each word are already extracted and stored, and thus the server can directly return these positions. Otherwise, the server may first perform OCR on the high quality copy.

Text is just one kind of possible metadata of the high-resolution digital pages from the server. Other metadata may include the definition of hotspots and the boundary and type of document elements, for examples figures, tables and paragraphs, which can be used to enhance the client interface. Using this type of metadata, the user can take advantage of the “point-and-click” operation to, for example, open a URL or copy a figure in a paper document.

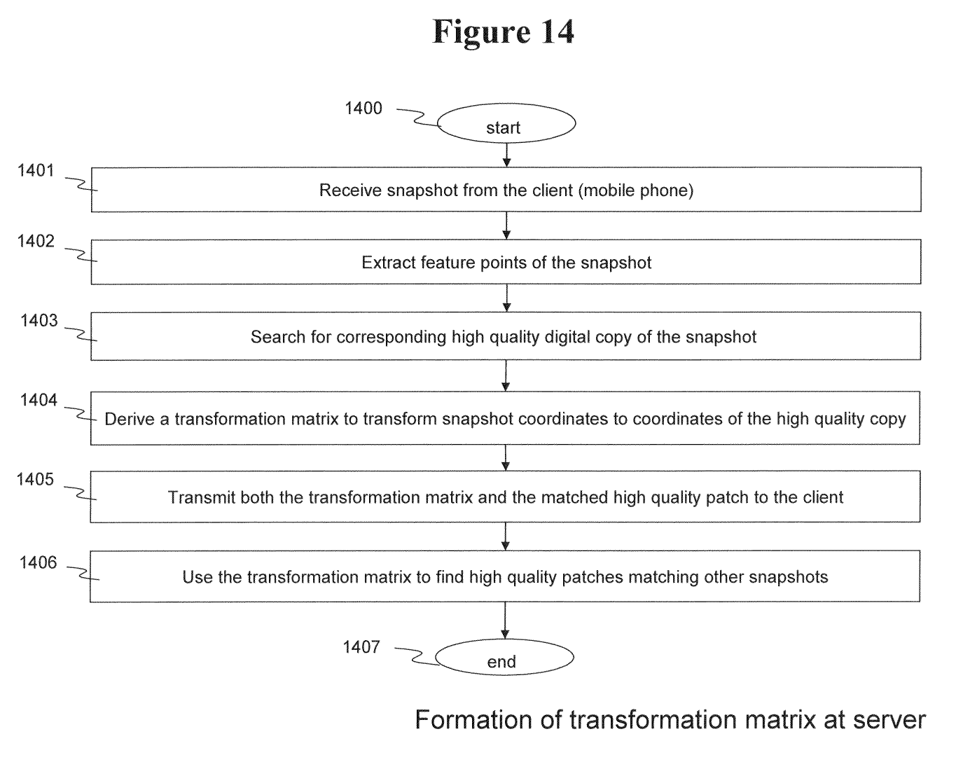

FIG. 14 shows a flow chart of a method of forming a transformation matrix to be utilized in conjunction with the enhance-by-original method, according to aspects of the present invention. The method begins at 1400. At 1401, the raw snapshot is received at the server from the client that may be the mobile phone. At 1402, distinctive feature points are extracted from the snapshot. Such features points may be extracted according to various image analysis methods. At 1403, based on the extracted feature points, the server searches the database for high quality counterparts of the snapshot. At 1404, based on the feature points of the snapshot and the corresponding feature points in the corresponding high quality patch, the server derives a transformation matrix for transforming the feature points of the snapshots captured by the mobile phone into the corresponding points on the corresponding high quality digital copies that are saved on the server. At 1405, the server transmits the high quality patch to the mobile phone. Alternatively, both the high quality patch and the transformation matrix may be transmitted to the mobile phone. At 1406, the mobile phone may use the transformation matrix for subsequent operations. At 1407, the method ends.

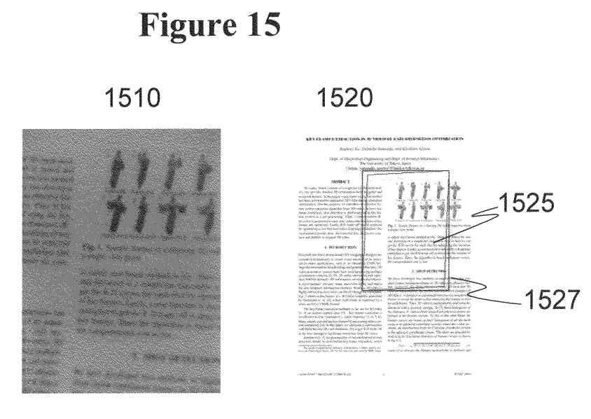

FIG. 15 shows a schematic depiction of the results of using a transformation matrix between phone-captured snapshots to obtain an original content, according to the aspects of the present invention. The method that constructs the transformation between phone-captured snapshots and original digital pages in the database was tested. A computer program was prepared for calculating the transformation matrix between a snapshot of a physical patch and its matched digital page. As FIG. 15 demonstrates, the resulting matrix can map snapshots into their corresponding digital pages with good precision. A document snapshot 1510 captured by a mobile phone is shown on the left and a digital page 1520 including a matched patch 1527 is shown to the right of the snapshot. An internal quadrangle 1525 is shown that corresponds to the area of the distorted snapshot 1510. A bounding box is also shown for the matched patch 1527 that bounds the distorted area of the snapshot 1525. The matching of the matched patch 1527 to the snapshot 1525 is performed using the transformation matrix.

As would be appreciated by those of skill in the art, achieving a perfect transformation is not necessary, because the users can refine their initial selection.

It should be noted that the Refine selection step 911 shown in In FIG. 9 can be performed by the user in another, alternative, way. Specifically, rather than using a stylus or a finger on the phone screen, the user can also move the phone itself over the paper document to select content, which will be referred to herein as phone gestures. In other words, she/he can apply phone gestures to control the command system. Exemplary gestures which can be used by the user to select content include Marquee, lasso, margin bar, underline, cross, dip, bracket.

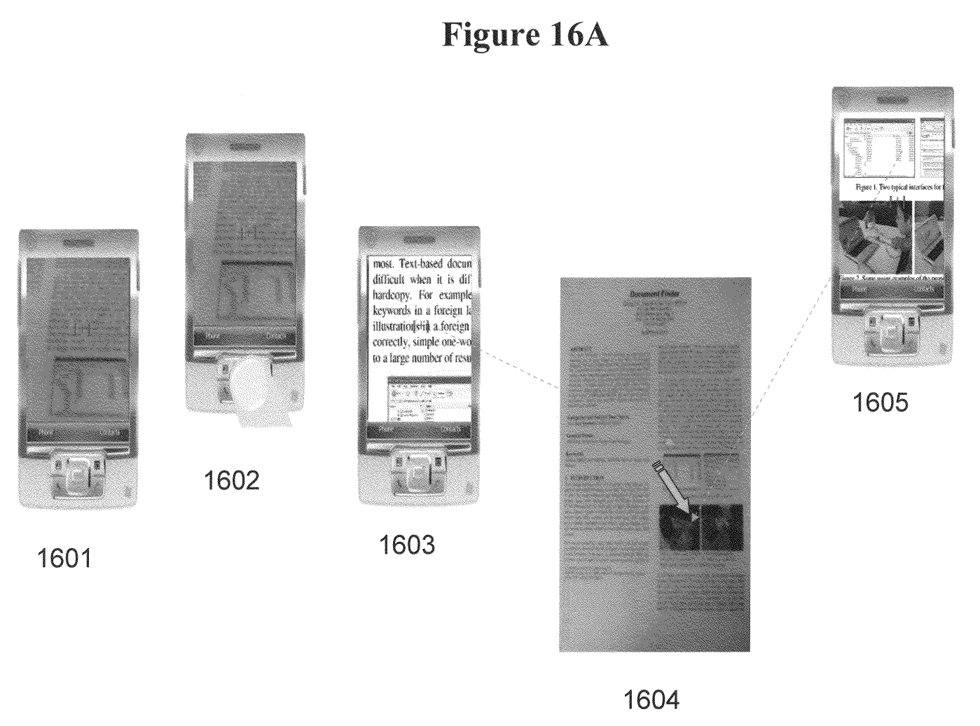

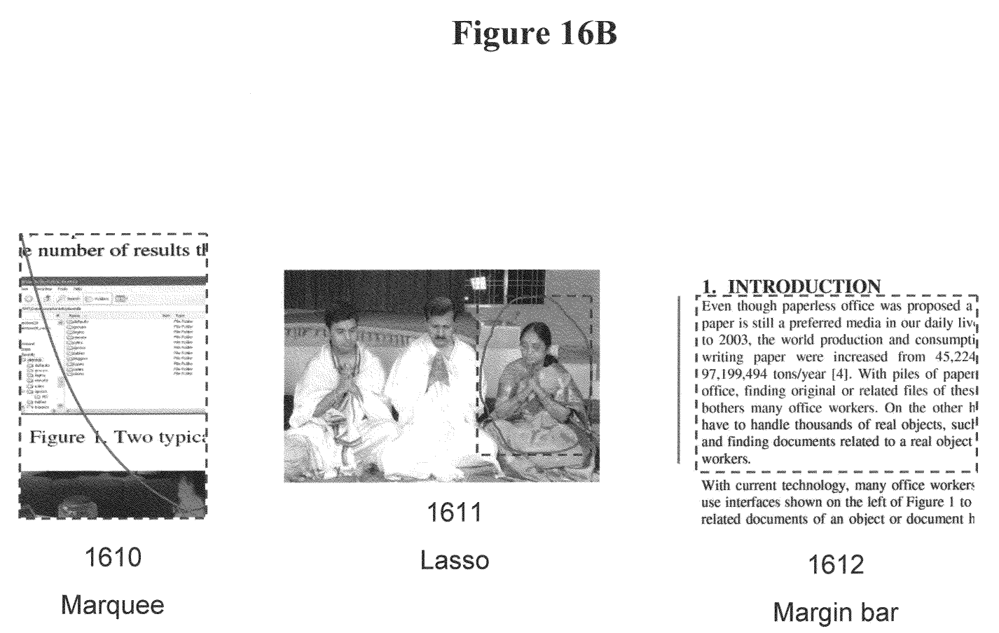

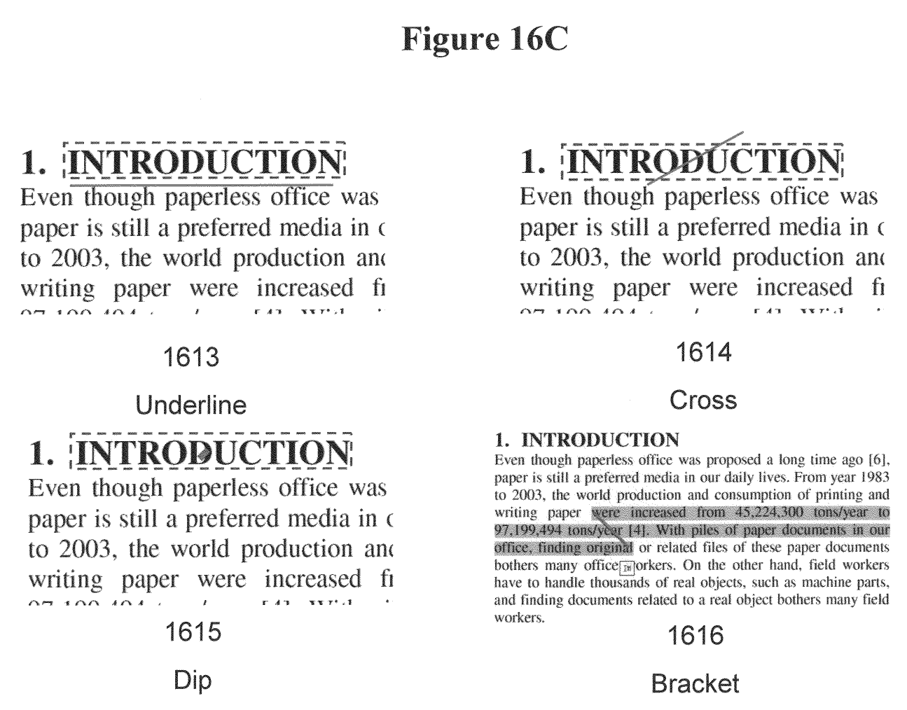

FIG. 16A shows a schematic depiction of a real-time phone-paper interaction in a sweep mode, according to aspects of the present invention. Specifically, this figure shows an aspect of the present invention that combines motion detection with image recognition to achieve real time scanning of a document. It is more difficult and CPU intensive to conduct document recognition than motion detection. Therefore, even when document recognition can not be done in real time, motion detection may still be done in real time. Accordingly, some aspects of the present invention use image-based motion detection to estimate digital patches between two image recognition sessions of camera images. In this aspect of the invention, the device is enabled to continually browse dynamic contents associated with the paper and to perform phone-movement based gestures. As a result, a device according to this aspect of the present invention includes a feature that enables fine-grained continuous phone-paper interaction on markerless and language-independent paper documents. In alternative implementations, non-image-based motion detection may also be employed. For instance, accelerometers can be utilized to achieve the non-image-based motion detection.

Going back to FIG. 16A, at step 1601, the user points the cross hair on the screen of the phone to the initial position within the document. At step 1602, the user engages the button on the phone to input the initial position into the phone and to switch to the sweep mode. At step 1603, the inventive system recognizes the current camera image and presents the matching high-resolution digital patch. At step 1604, the user sweeps the cell phone to point to another location, just like the user would move a computer mouse. During this motion, the inventive system continually detects the relative movement of the camera and the paper and updates the digital patch. Such detection takes much less CPU cycles than recognition, but may have accumulated errors. At step 1605, the resulting document region selected via the phone movement is presented to the user.

FIGS. 16B and 16C illustrate various exemplary phone gestures, which can be used by the user in the sweep mode to perform selection of the content. Specifically, in the Marquee selection method 1610 illustrated in FIG. 16A, the ends of the line drawn by the user through the target content define two opposite comets of a rectangle, which encompasses the desired selection. In other words, all the content in the resulting rectangle is being selected. In Lasso method 1611, the user draws a shape around the content to be selected. In the Margin Bar method 612, the user draws a line on the margin bar of a text content, resulting in the selection of the text on the lines crossed by the bar. The user can also underline, cross or dip the content to be selected as illustrated by methods 1613-1615 shown in FIG. 16C. Finally, the user may bracket the target textual content with a line drawn through the textual content, as shown in method 1616. As would be appreciate by those of skill in the art, the above description of possible content selection gestures is not exhaustive and other similar gestures can be used as well. Thus, the present invention is not limited to the disclosed gestures only.

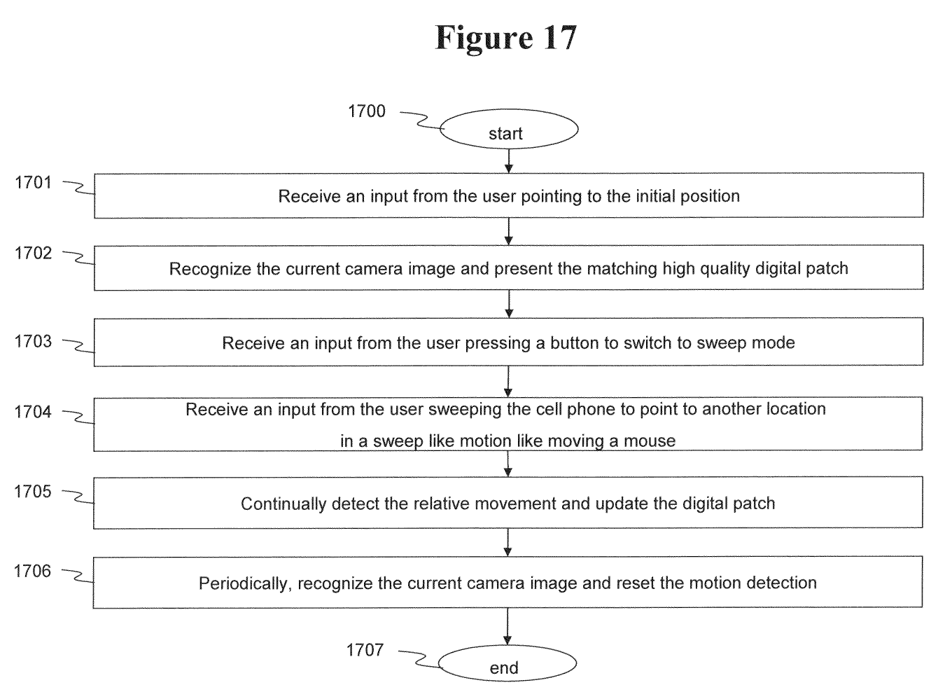

FIG. 17 shows a flow chart of a method of providing high resolution document images through semi-real time phone-paper interaction in a sweep mode, according to aspects of the present invention. The process begins at 1700. At 1701, the mobile phone system receives an input from the user pointing to an initial position. At 1702, the system recognizes the current camera image and presents the matching high-resolution digital patch to the user on the screen of the mobile phone. At 1703, the mobile phone system receives an input from the user pressing a button to switch to sweep mode. At 1704, the system receives another input from the user who is sweeping the mobile phone to point to another location. This sweep motion is like moving a mouse. At 1705, the system continually detects the relative movement and updates the digital patch. Such detection takes fewer CPU cycles than recognition, but may include accumulated errors. At 1706, the system periodically, recognizes the current camera image and resets the motion detection based on the camera image that has been recognized. At 1707, the method ends.

The complete image recognition sessions occur at steps 1701 and 1706 and the interval in between the two corresponds to step 1705 in FIG. 17. In the interval between the two complete image recognition sessions that are data and CPU intensive, the image is deduced based on the initial image, as an initial condition, and the movement of the mobile phone. In one embodiment of the present invention, at 1705, in addition to motion detection, a low-dimensional feature descriptor vector of the image being swept by the mobile phone is also continually sent to the server. As would be appreciated by those of skill in the art, this low-dimensional descriptor is not necessary for all implementations of the inventive technique. Therefore, the present invention is not limited in this respect. For example, when the user turns to a different document page, the image-based motion detection can used as well to find the aforesaid page-change event. However, for implementations of the inventive system with non-image-based motion detection (e.g. having an accelerometer), this low-dimensional feature descriptor is useful.

In this aspect of the invention, two pieces of information are used by the server for matching a high quality patch to the location of the mobile phone: the first piece being the relative motion of the mobile phone with respect to the initial position and the second piece of information being image data of the image currently in view of the mobile phone during the sweep. In this alternative aspect of the present invention, image data being transmitted from the mobile phone to the server in the interval between two image recognition sessions is sparse and is used only to veto the image that is deduced from the motion of the mobile phone combined with an initial image. Therefore, if the user, for example, moves to a different page of the document while holding the mobile phone at the same location, the sparse image data of the second page inform the server that irrespective of the motion, the image has changed. At that point, the system may engage in another image recognition session that involves the transmission and processing of more image data. For example, if image descriptor vectors are being transmitted by the mobile phone to the server to assist the server in image recognition, the image descriptor vectors transmitted for periodic resetting of the motion detection have a large dimension and convey a large amount of data while the image descriptor vectors that are transmitted continually as the mobile phone is sweeping, have a smaller dimension and do not convey a large amount of data. It should be also noted that the aforesaid image descriptors may be extracted by the server receiving the images.

Testing some prototypes of the aspects of the present invention has shown the success rate of the document identification algorithm to be high with clean documents that do not include excessive mark-ups. For example, 1000 pages from the 2006 International Conference on Mathematical Education (ICME06) proceeding was used for testing the system. Each page was converted to a 306 by 396 image and fed into the system as a training image to extract key points and feature vectors. The images of the pages were randomly scaled to between 0.18 to 2 times their original sized and rotated between 0° and 360° for each page to generate 3000 test images, with three images corresponding to each page. The 3000 test images were fed to the system. The page recognition rate of a system implemented based on the aspects of the present invention was obtained to be 99.9% for these input images.

Further, because the method uses local features, annotated document do not affect the performance significantly.

The above description provides a framework enabling token and point level operations on language independent documents through a paper and camera phone based interface. The framework may be used to realize keyword finding in paper documents with a camera phone; to realize web search for words in paper documents with a camera phone; to realize e-dictionary for words in paper documents with a camera phone; or to support token and point level multimedia annotations on paper documents with a camera phone. The framework may be used to realize copy-paste operations on paper documents with a camera phone; to construct photo collages from portions of printed photos with a camera phone; or to play dynamic contents of printed presentation slides with a camera phone.

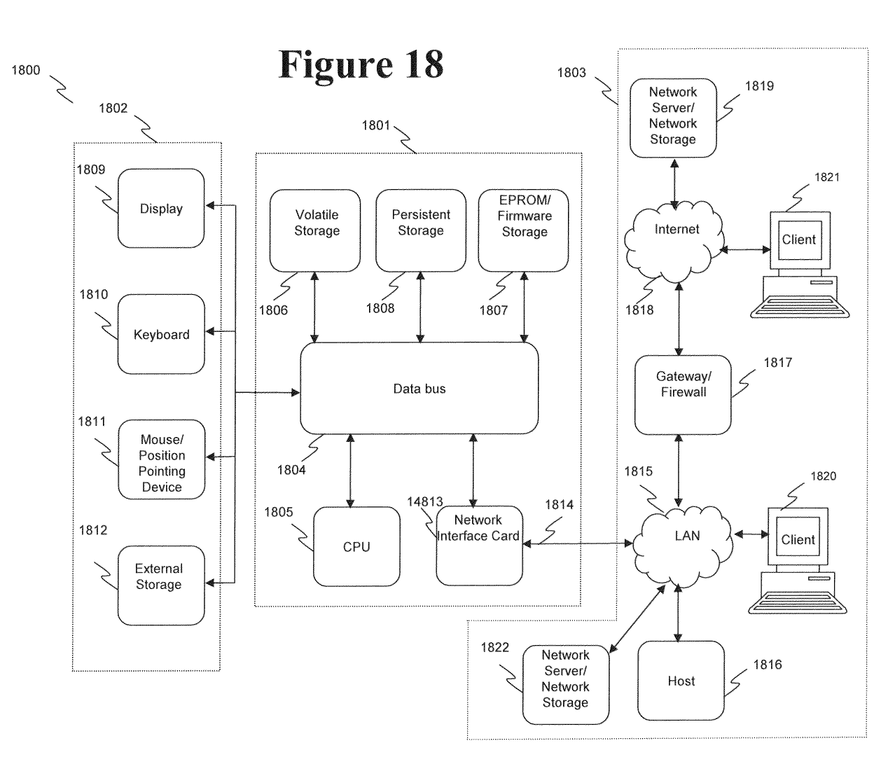

FIG. 18 illustrates an exemplary embodiment of a computer platform upon which the inventive system may be implemented. The system 1800 includes a computer/server platform 1801, peripheral devices 1802 and network resources 1803.

The computer platform 1801 may include a data bus 1804 or other communication mechanism for communicating information across and among various parts of the computer platform 1801, and a processor 1805 coupled with bus 1801 for processing information and performing other computational and control tasks. Computer platform 1801 also includes a volatile storage 1806, such as a random access memory (RAM) or other dynamic storage device, coupled to bus 1804 for storing various information as well as instructions to be executed by processor 1805. The volatile storage 1806 also may be used for storing temporary variables or other intermediate information during execution of instructions by processor 1805. Computer platform 1801 may further include a read only memory (ROM or EPROM) 1807 or other static storage device coupled to bus 1804 for storing static information and instructions for processor 1805, such as basic input-output system (BIOS), as well as various system configuration parameters. A persistent storage device 1808, such as a magnetic disk, optical disk, or solid-state flash memory device is provided and coupled to bus 1801 for storing information and instructions.

Computer platform 1801 may be coupled via bus 1804 to a display 1809, such as a cathode ray tube (CRT), plasma display, or a liquid crystal display (LCD), for displaying information to a system administrator or user of the computer platform 1801. An input device 1810, including alphanumeric and other keys, is coupled to bus 1801 for communicating information and command selections to processor 1805. Another type of user input device is cursor control device 1811, such as a mouse, a trackball, or cursor direction keys for communicating direction information and command selections to processor 1804 and for controlling cursor movement on display 1809. This input device typically has two degrees of freedom in two axes, a first axis (e.g., x) and a second axis (e.g., y), that allows the device to specify positions in a plane.

An external storage device 1812 may be connected to the computer platform 1801 via bus 1804 to provide an extra or removable storage capacity for the computer platform 1801. In an embodiment of the computer system 1800, the external removable storage device 1812 may be used to facilitate exchange of data with other computer systems.

The invention is related to the use of computer system 1800 for implementing the techniques described herein. In an embodiment, the inventive system may reside on a machine such as computer platform 1801. According to one embodiment of the invention, the techniques described herein are performed by computer system 1800 in response to processor 1805 executing one or more sequences of one or more instructions contained in the volatile memory 1806. Such instructions may be read into volatile memory 1806 from another computer-readable medium, such as persistent storage device 1808. Execution of the sequences of instructions contained in the volatile memory 1806 causes processor 1805 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1805 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 1808. Volatile media includes dynamic memory, such as volatile storage 1806. Transmission media includes coaxial cables, copper wire and fiber optics, including the wires that comprise data bus 1804.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 1805 for execution. For example, the instructions may initially be carried on a magnetic disk from a remote computer. Alternatively, a remote computer can load the instructions into its dynamic memory and send the instructions over a telephone line using a modem. A modem local to computer system 1800 can receive the data on the telephone line and use an infra-red transmitter to convert the data to an infra-red signal. An infra-red detector can receive the data carried in the infra-red signal and appropriate circuitry can place the data on the data bus 1804. The bus 1804 carries the data to the volatile storage 1806, from which processor 1805 retrieves and executes the instructions. The instructions received by the volatile memory 1806 may optionally be stored on persistent storage device 1808 either before or after execution by processor 1805. The instructions may also be downloaded into the computer platform 1801 via Internet using a variety of network data communication protocols well known in the art.

The computer platform 1801 also includes a communication interface, such as network interface card 1813 coupled to the data bus 1804. Communication interface 1813 provides a two-way data communication coupling to a network link 1814 that is connected to a local area network (LAN) 1815. For example, communication interface 1813 may be an integrated services digital network (ISDN) card or a modem to provide a data communication connection to a corresponding type of telephone line. As another example, communication interface 1813 may be a local area network interface card (LAN NIC) to provide a data communication connection to a compatible LAN. Wireless links, such as well-known 802.11a, 802.11b, 802.11g and Bluetooth may also be used for network implementation. In any such implementation, communication interface 1813 sends and receives electrical, electromagnetic or optical signals that carry digital data streams representing various types of information.

Network link 1813 typically provides data communication through one or more networks to other network resources. For example, network link 1814 may provide a connection through LAN 1815 to a host computer 1816, or a network storage/server 1817. Additionally or alternatively, the network link 1813 may connect through gateway/firewall 1817 to the wide-area or global network 1818, such as an Internet. Thus, the computer platform 1801 can access network resources located anywhere on the Internet 1818, such as a remote network storage/server 1819. On the other hand, the computer platform 1801 may also be accessed by clients located anywhere on the LAN 1815 and/or the Internet 1818. The network clients 1820 and 1821 may themselves be implemented based on the computer platform similar to the platform 1801.

The LAN 1815 and the Internet 1818 both use electrical, electromagnetic or optical signals that carry digital data streams. The signals through the various networks and the signals on network link 1814 and through communication interface 1813, which carry the digital data to and from computer platform 1801, are exemplary forms of carrier waves transporting the information.

Computer platform 1801 can send messages and receive data, including program code, through the variety of network(s) including Internet 1818 and LAN 1815, network link 1814 and communication interface 1813. In the Internet example, when the system 1801 acts as a network server, it might transmit a requested code or data for an application program running on client(s) 1820 and/or 1821 through Internet 1818, gateway/firewall 1817, LAN 1815 and communication interface 1813. Similarly, it may receive code from other network resources.

The received code may be executed by processor 1805 as it is received, and/or stored in persistent or volatile storage devices 1808 and 1806, respectively, or other non-volatile storage for later execution. In this manner, computer system 1801 may obtain application code in the form of a carrier wave.

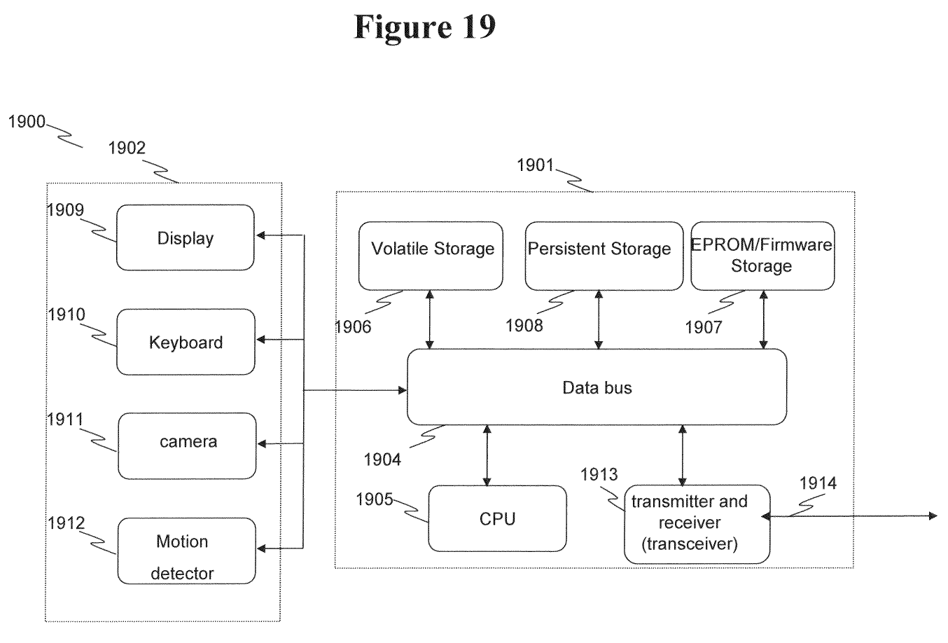

FIG. 19 illustrates an exemplary functional diagram of how aspects of the present invention relate to a computer platform. A mobile phone 1900 according to the aspects of the present invention includes a computing platform 1901 that in turn includes a CPU 1905, a volatile storage medium 1906, and a persistent storage medium 1908 that are coupled together via a data bus 1904. The computing platform 1901 may also include an EPROM or firmware storage 1907, and a transceiver 1913 that is in communication with a network through an antenna 1914. The computing platform is coupled to peripheral devices 1902 including a display 1909, a keyboard 1910, a camera 1911, and a motion detector 1912. The motion detector may be a location detector, such as a global positioning system, combined with an accelerometer. The motion detector may measure direction and speed of motion of the camera with respect to an initial location such that the location of the camera may be determined. Alternatively, the motion detector may directly determine the location of the camera at any point in time during the sweep.

The camera 1911 may be used to capture a snapshot of a document that is sent to the CPU for image processing and for developing the image descriptor vectors associated with the distinctive features of the captured snapshot. The motion detector 1912 may be used to obtain the location of the camera with respect to an initial position during a sweep motion of the mobile phone. The display 1909 may be used for viewing the captured snapshots as well as the high-quality images that are received from a server in communication with the mobile phone. The snapshots are sent via the antenna 1914 and the high-quality images are received via the same antenna. The keyboard 1910 may be used for annotating the snapshot or the high-quality image before transmitting it back to the server. The persistent storage 1908 and the firmware storage 1907 may be used to store programs that calculated the feature descriptor vectors for each image or store the transformation matrix.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct a specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the inventive system for interaction with mobile phone. It is intended that the specification and examples be considered as exemplary only, with a true scope and spirit of the invention being indicated by the following claims and their equivalents.

What is claimed is:

1. A mobile system comprising:
a camera for capturing a snapshot of a rendering of a document;
a transceiver for transmitting the snapshot to a server and for receiving a digital copy of the document matched to the snapshot; and
an interface for displaying the digital copy to a user,
wherein the camera, the transceiver and the interface are integrated within a mobile phone.

2. The system of claim 1,
wherein the snapshot is distorted and blurred, and
wherein the digital copy is distortion-less and has high resolution.

3. The system of claim 1,
wherein boundaries of a digital patch within the digital copy of the document form a bounding rectangle around the snapshot, and
wherein the bounding rectangle is not restricted to predetermined patches of the digital copy.

4. The system of claim 1,
wherein a matching of the digital copy to the snapshot is language independent.

5. The system of claim 1,
wherein the mobile phone further comprises a processor for extracting image descriptors from the snapshot, and
wherein the transceiver transmits the image descriptors extracted from the snapshot to the server for being matched with image descriptors of the digital copy.

6. The system of claim 1,
wherein the interface receives a command for an operation from the user, and
wherein the operation is performed at point level and token level on the digital copy.

7. The system of claim 6, wherein the operation is selected from a group consisting of:
finding a keyword in the document,
conducting a web search for a word in the document,
accessing e-dictionary for a word in the document,
providing a token and a point level multimedia annotation on the document,
performing a copy-paste operation on the document,
constructing a photo collage from portions of the document, and
using the interface to play a dynamic content associated with the document.

8. The system of claim 1,
wherein the mobile phone further comprises a motion detector for determining a location of the camera during a sweep of the camera over the paper copy of the document, and
wherein the interface displays the digital copy to the user according to the location of the camera during the sweep.

9. The system of claim 1, comprising:
the server,
wherein the server:
receives the snapshot,
extracts feature points from the snapshot,
searches for a digital patch corresponding to the snapshot by matching the feature points of the snapshot to feature points of the digital patch,
derives a transformation matrix to transform snapshot coordinates to digital patch coordinates, and
transmits the transformation matrix to the mobile phone.

10. The system of claim 1, comprising:
the server comprising a database for storing digital copies of a plurality of documents; and
a scanner for transforming paper copies of the plurality of documents into the digital copies of the plurality of documents.

11. The system of claim 1, wherein the document is a markerless document.

12. A server system comprising:
a database for storing digital copies of a plurality of paper documents;
a receiver for receiving a snapshot of a rendering of a document, the snapshot captured from the paper document by a mobile phone;
one or more processors for extracting feature points of the snapshot;
a search engine for searching for a digital patch corresponding to the snapshot by matching the feature points of the snapshot to feature points of the digital patch;
one or more processors for deriving a transformation matrix to transform snapshot coordinates to digital patch coordinates; and
a transmitter for transmitting the transformation matrix and digital metadata to the mobile phone.

13. A system comprising:
camera means for capturing a snapshot of a rendering of a document, wherein the camera means is integrated into a mobile phone;
transmitting means for transmitting the snapshot to a server;
receiving means for receiving from the server a digital copy of the document matched to the snapshot; and
displaying means for displaying the digital copy to a user.

14. The system of claim 13,
wherein the snapshot is distorted and blurred,
wherein the digital copy is distortion-less and has high resolution,
wherein boundaries of a digital patch within the digital copy form a bounding rectangle around boundaries of the snapshot, and
wherein the bounding rectangle is not restricted to predetermined patches of the digital document.

15. The system of claim 13,
wherein a matching of the digital copy of the document to the snapshot of the document is language independent.

16. The system of claim 13, further comprising:
extracting means for extracting image descriptors from the snapshot,
wherein the image descriptors of the snapshot are matched with image descriptors of the digital copy.

17. The system of claim 16, wherein the transmitting the snapshot comprises transmitting the image descriptors to the server, and
wherein the image descriptors of the snapshot are matched with the image descriptors of the digital copy at the server.

18. The system of claim 13, further comprising:
user interface means for receiving a command for an operation from the user; and
processing means for performing the operation at point level and token level on the digital copy of the document.

19. The system of claim 18, wherein the operation is selected from a group consisting of:
finding a keyword in the document,
conducting a web search for a word in the document,
accessing e-dictionary for a word in the document,
providing a token and a point level multimedia annotation on the document,
performing a copy-paste operation on the document,
constructing a photo collage from portions of the document, and
using the display means to play a dynamic content associated with the document.

20. The system of claim 13, further comprising:
location means for determining a location of the camera during a sweep of the camera over the paper copy of the document, wherein the displaying means display the digital copy to the user according to the location of the camera during the sweep.

21. A method comprising:
storing digital copies of a plurality of rendered documents in a database together with feature points associated with each of the digital copies;
receiving a snapshot of a paper copy of a document, the snapshot having been captured from the paper document by a mobile phone camera;
extracting feature points of the snapshot;
searching for a digital patch corresponding to the snapshot by matching the feature points of the snapshot to feature points of the digital patch;
deriving a transformation matrix to transform snapshot coordinates to digital patch coordinates; and
transmitting the transformation matrix to the mobile phone.
